(19) United States
(12) Patent Application Publication
(10) Pub. No.: US 2010/0257961 A1
(43) Pub. Date: Oct. 14, 2010

(54) DOUBLE CLUTCH TRANSMISSION

(75) Inventors: Wolfgang RIEGER, Friedrichshafen (DE); Philip RECKER, Friedrichshafen (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF Friedrischafen AG, Friedrichshafen (DE)

(21) Appl. No.: 12/758,955

(22) Filed: Apr. 13, 2010

(30) Foreign Application Priority Data
Apr. 14, 2009 (DE) 10 2009 002 344.5

(51) Int. Cl. F16H 3/20

(52) U.S. Cl. 74/331

(57) ABSTRACT

A double clutch transmission comprising two clutches which each have input sides connected to a drive shaft and output sides respectively connected to one of two transmission input shafts coaxial arranged with respect to one another. At least two countershafts having toothed idler gearwheels pivotally supported thereon while toothed fixed gearwheels are disposed on the transmission input shafts and which engage with at least some of the idler gearwheels. A plurality of coupling devices are provided for coupling an idler gearwheel to the respective countershaft in a rotationally fixed manner. An output gearwheel, on each respective countershaft, is coupled to gearing of an output shaft. At least one shift element is provided for connecting two toothed gearwheels in a rotationally fixed manner such that a plurality of power shifting forward gears and at least one reverse gear can be shifted.

This application claims priority from German patent application serial no. 10 2009 002 344.5 filed Apr. 14, 2009.

### FIELD OF THE INVENTION

The present invention relates to a double clutch transmission.

### BACKGROUND OF THE INVENTION

A six or seven gear double clutch transmission is known from the publication DE 103 05 241 A1. The double clutch transmission comprises two clutches, which are each connected to the driveshaft at the input sides thereof, and to one of the two transmission input shafts at the respective output sides thereof. The two transmission input shafts are disposed coaxially to each other. Furthermore, two countershafts are disposed axially parallel to the two transmission input shafts, the idler gears of mesh together with the fixed gears of the transmission input shafts. Furthermore, coupling devices are rotationally supported in an axially displaceable manner on the countershafts in order to switch the respective toothed gearwheels. The respectively selected transmission ratio is transferred to a differential via the output gears. In order to realize the desired transmission ratio steps in the known double clutch transmission a plurality of gear planes such that a significant amount of construction space is required during installation.

Furthermore, a spur gear multi-speed transmission is known from the publication DE 38 22 330 A1. The spur gear multi-speed transmission comprises a double clutch that can be switched under load, one part of which is connected to a driveshaft, and another part of which is connected to a hollow driveshaft that is rotationally supported on the driveshaft. For certain transmission ratios the driveshaft may be coupled to the hollow driveshaft via a shift element.

A power-shift transmission having two clutches is known from the publication DE 10 2004 001 961 A1, which are each associated with a subtransmission. The transmission input shafts of both subtransmissions are disposed coaxially to each other and engage with idler gears of the associated countershafts via fixed gears. The respective idler gears of the countershafts may be connected to the respective countershaft by means of associated shift elements in a rotationally fixed manner. An eight-shift transmission is known from the publication, wherein a further shift element is provided for coupling the two transmission input shafts in order to realize a further transmission ratio step. The eight-shift transmission in this embodiment requires at least six gear planes in both subtransmissions in order to be able to realize the transmission ratio steps. This leads to an undesired elongation of the construction length in axial direction such that the possibility of installation into a vehicle is substantially limited.

A further power-shift transmission is also known from the published patent DE 10 2005 028 532 A1, which comprises two input shafts and only one countershaft. For example, a nine-speed transmission in this embodiment requires at least seven gear planes in order to be able to realize the transmission ratio steps. This leads to an undesired elongation of the construction length in the I direction. Furthermore, an additional shaft having a gear plane is required to realize the reverse transmission ratios, which comprises a shift element and two toothed gears. A further disadvantage arises in the known power-shift transmission in that power shifts are possible only between the first and the second gears.

### SUMMARY OF THE INVENTION

The present invention is therefore based on the object of providing a double clutch transmission of the type described above, wherein a plurality of power shifting translation ratio steps can be realized in a manner that is as cost effective as possible, with as few components as possible, and at a small required construction space.

Accordingly, a double clutch transmission optimized in terms of construction size is provided, comprising two clutches, the input sides of which are connected to a driveshaft and the respective output side of which is connected to one of two transmission input shafts that are disposed, for example, coaxially to each other. The double clutch transmission comprises at least two countershafts or the like, on which toothed gearwheels embodied as idler gears are rotatably supported, wherein toothed gearwheels embodied as fixed gears and disposed on the transmission input shafts in a rotationally fixed manner are provided, which engage with at least some of the idler gears. Furthermore, a plurality of coupling devices is provided for the rotationally fixed connection of an idler gear to the countershaft. The double clutch transmission according to the invention comprises an output gear, or a constant pinion, respectively, provided on each of the countershafts, which is coupled to a gearing of a driveshaft in order to connect the respective countershaft to the drive, and at least one actuatable, or closeable shift element or the like as a so-called winding path gear shift element for the rotationally fixed connection of two toothed gearwheels, wherein a plurality of power-shifting forward gears and at least one power-shifting reverse gear may be shifted.

According to the invention the double clutch transmission provided, preferably comprises only six gear planes, by means of which at least nine power shifting forward gears are realized at a small required construction space.

For example, the six gear planes may be formed by at least three dual gear planes and, for example, a maximum of three single gear planes, wherein one idler gear of the first and the second countershafts is associated with one fixed gear of one of the transmission input shafts in each dual gear plane, and at least one idler gear may be utilized for at least two gears such that at least one power shifting winding path gear may be shifted via one shift element. Due to the possible multiple uses of idler gears, a maximum number of transmission ratios may be realized in the double clutch transmission provided with as few gear planes as possible, wherein preferably all forward gears and at least one reverse gear may be power shifted in sequential order.

In order to optimize the graduation in the double clutch transmission provided according to the invention, a further dual gear plane may also be replaced with two single gear planes, in that a fixed gear is replaced with two fixed gears. In this manner a particularly harmonic, progressive gear graduation may be achieved. It is also possible to replace two single gear planes with one dual gear plane.

The double clutch transmission provided may preferably be embodied as a 9-gear transmission having at least nine power shifted gear steps. Due to the short construction as opposed to known transmission arrangements the double clutch transmission is particularly suited for a front lateral construction in a vehicle. However, other types of constructions are also possible depending on the type and construction space situation of the vehicle in question.

Preferably the first forward gear and/or the highest power-shifting forward gear in the double clutch transmission provided may be a winding path gear. Furthermore, at least one reverse gear may also be embodied as a winding path gear. For example, depending on the construction, three to five shifting idler gears may be associated with the first countershaft, and five to six shifting idler gears may be associated with the second countershaft, wherein are each meshing with fixed gears of the associated transmission input shaft.

If the last or next to last gear step is configured to be higher than the respective gear positioned before the same, a particularly high output torque or drive power may be provided in case of a reverse shifting required by the driver.

Advantageously, a maximum of six shift points are required at each countershaft in the double clutch transmission according to the invention. In total only ten shift points are utilized at both countershafts in order to realize the recommended gear steps.

Within the course of a possible variant embodiment the invention may provide that the double clutch transmission also comprises four dual gear planes such that accordingly only two single gear planes are provided in order to realize the total of six gear planes. Other configurations are also possible.

The invention may further provide that the idler gear of the second subtransmission can be connected to the idler gear of the first subtransmission at the second countershaft via an alternative or an additional shift element such that at least one reverse gear and/or at least one crawler gear, and/or at least one overdrive gear as the winding path gear may be shifted via the shift element.

It may further be provided that the idler gear of the second subtransmission can be connected to the idler gear of the first subtransmission via an alternative or additional shift element at the second countershaft such that the ninth forward gear and one reverse gear and/or a crawler gear may be shifted as the winding path gear via the shift element.

Therefore, winding path gears may be realized via the at least one shift element with the use of the double clutch transmission according to the invention, wherein toothed gear wheels of both subtransmissions are coupled to each other in order to thereby realize a flow of power through both subtransmissions. For this purpose the respectively utilized shift element serves for coupling two idler gears, thus bringing the transmission input shafts to be dependent upon one another.

In the double clutch transmission the arrangement of the shift elements may be varied for coupling two certain idler gears such that the shift elements do not mandatorily need to be disposed between the idler gears to be coupled. Accordingly, other arrangement positions of the respective shift element are also conceivable in order to, for example, optimize the connection to an actuator system.

According to a possible embodiment it may be provided in the double clutch transmission that the first gear plane and the second gear plane each as a single gear plane, and the third gear plane designed as a dual gear plane comprise fixed gears at the second transmission input shaft of the second subtransmission, wherein the fourth gear plane and the fifth gear plane each as dual gear planes, and the sixth gear plane designed as a single gear plane comprise three fixed gears at the first transmission input shaft of the first subtransmission.

Within the scope of a further variant embodiment of the invention it may also be provided that in the double clutch transmission the first gear plane designed as a single gear plane and the second gear plane and the third gear plane each as a dual gear plane comprise three fixed gears on the second transmission input shaft of the second subtransmission, wherein the fourth gear plane and the fifth gear plane each as a dual gear plane, and the sixth gear plane designed as a single gear plane may comprise three fixed gears of the first transmission input shaft of the first subtransmission.

A subsequent variant embodiment of the invention may provide that the first gear plane designed as a dual gear plane and the second gear plane designed as a single gear plane and the third gear plane designed as a dual gear plane comprise three fixed gears on the second transmission input shaft of the second subtransmission, wherein the fourth gear plane designed as a dual gear plane or as a single gear plane and the fifth gear plane designed as a dual gear plane and the sixth gear plane designed as a single gear plane comprise three fixed gears of the first transmission input shaft of the first subtransmission.

In order to provide the reversal of rotation required for realizing reverse gears in the double clutch transmission according to the invention, at least one intermediate gear or the like may be utilized which is disposed on an intermediate shaft. It is also possible that one of the idler gears of a countershaft serves as the intermediate gear for at least one reverse gear. No additional intermediate shaft is necessary for the reverse gear transmission ratio in this case, since one of the idler gears meshes both with a fixed gear and with a further shiftable idler gear of the other countershaft. In this manner the intermediate gear required for the reverse gear is disposed on a countershaft as a shiftable idler gear and further serves for realizing at least one further forward gear. The intermediate gear may also be configured as a stepped gear, regardless of whether the same is disposed on the countershaft or on an additional intermediate shaft. It is also possible that the intermediate gear is not disposed on an already existing countershaft, but is provided on a further separate shaft, such as a third countershaft.

In order to obtain the desired transmission ratio step it may be provided in the double clutch transmission according to the invention that at least one bidirectionally operative coupling device or the like is disposed on each countershaft. The provided coupling devices may each connect an associated idler gear to the countershaft in a rotationally fixed manner in the activated or closed state, depending on the actuating direction. Furthermore, a unidirectionally operative coupling device or the like may also be disposed on at least one of the countershafts. As the coupling devices, for example, hydraulically, electrically, pneumatically, mechanically actuated clutches or also positive-locking jaw clutches, as well as any type of synchronizations may be utilized, which serve for the rotationally fixed connection of an idler gear to a countershaft. It is possible that a bidirectionally operative coupling device is replaced with two unidirectionally operative coupling devices, or vice versa.

It is conceivable that the arrangement possibilities of the toothed gearwheels states may be varied, and the number of toothed gearwheels and the number of coupling devices may be changed in order to realize even further power-shift or non-power-shift gears as well as construction and component savings in the double clutch transmission provided. In particular, fixed gears of dual gear planes may be divided into two fixed gears for two single gear planes. Any step changes may be improved in this manner. It is further also possible to exchange the countershafts. The subtransmissions may also be exchanged, i.e. the same are mirrored about a vertical axis. For this purpose the hollow and solid shafts are exchanged. In this manner it is possible, for example, to dispose the smallest toothed gear on the solid shaft in order to further optimize the utilization of the existing construction space. Furthermore, adjacent gear planes may also be exchanged, for example, in order to optimize shaft deflection and/or to optimally connect a shift actuating system. Furthermore, the respective arrangement position of the coupling devices to the gear plane may be varied. The effective direction of the coupling devices may further also be changed.

The gear numerations were defined freely. It is also possible to add a crawler, or crawler gear and/or an overdrive or overdrive gear in order to improve, for example, the terrain properties or the acceleration behavior in a vehicle. Furthermore, a first gear may be omitted, i.e. in order to better optimize the totality of the step changes. The gear numeration varies accordingly with these measures.

Regardless of the respective variant embodiments of the double clutch transmission, the driveshaft and the output shaft may preferably also not be disposed coaxially to each other, which realizes a particularly construction space saving arrangement. For example, the shafts thereby spatially disposed in a successive manner may also be positioned at a slight offset to each other. In this arrangement a direct gear with transmission ratio one may be realized via gear engagement and may be positioned advantageously into the sixth to ninth gear in a relatively free manner. Other arrangement possibilities of the driveshaft and of the output shaft are also conceivable.

Preferably, the double clutch transmission provided is equipped with an integrated output step. The output step may comprise a fixed gear on the driveshaft as the output gear, which is engaged both in a first output gear as the fixed gear of the first countershaft and in a second output gear as the fixed gear of the second countershaft. However, it is possible that at least one of the output gears is embodied as a shifting toothed gear.

Advantageously the lower forward gears and the reverse gears may be actuated via a starting or shifting clutch in order to thereby concentrate higher loads to clutch and thereby be able to embody the second clutch in a more construction space and cost-effective manner. In particular, the gear planes may be disposed in the double clutch transmission provided such that startup can be achieved both via the internal transmission input shaft or also via the exterior transmission input shaft, and thereby via the respectively better suitable clutch, which is also enabled in a construction of the double clutch transmission that is concentrically disposed and nestled. For this purpose the gear planes may be disposed or exchanged in a respective mirror inverted manner.

Regardless of the respective variant embodiment the gear planes provided in the double clutch transmission may, for example, be interchanged. It is also possible that two single gear planes are utilized instead of a dual gear plane, and/or vice versa.

### BRIEF DESCRIPTION OF THE DRAWINGS

The present invention is explained in further detail below based on the drawings. They show:

FIG. 1 a schematic view of a first variant embodiment of a nine-gear double clutch transmission according to the invention;

FIG. 2 a shift pattern of the first variant embodiment according to FIG. 1;

FIG. 3 a schematic view of a second variant embodiment of the nine-gear double clutch transmission according to the invention;

FIG. 4 a shift pattern of the second variant embodiment according to FIG. 3;

FIG. 5 a schematic view of a third variant embodiment of the nine-gear double clutch transmission according to the invention;

FIG. 6 a shift pattern of the third variant embodiment according to FIG. 5;

FIG. 7 a schematic view of a fourth variant embodiment of the nine-gear double clutch transmission according to the invention;

FIG. 8 a shift pattern of the fourth variant embodiment according to FIG. 7;

FIG. 9 a schematic view of a fifth variant embodiment of the nine-gear double clutch transmission according to the invention;

FIG. 10 a shift pattern of the fifth variant embodiment according to FIG. 9;

FIG. 11 a schematic view of a sixth variant embodiment of the nine-gear double clutch transmission according to the invention;

FIG. 12 a shift pattern of the sixth variant embodiment according to FIG. 11;

FIG. 13 a schematic view of a seventh variant embodiment of the nine-gear double clutch transmission according to the invention;

FIG. 14 a shift pattern of the seventh variant embodiment according to FIG. 13;

FIG. 15 a schematic view of an eighth variant embodiment of the nine-gear double clutch transmission according to the invention;

FIG. 16 a shift pattern of the eighth variant embodiment according to FIG. 15;

FIG. 17 a schematic view of a ninth variant embodiment of the nine-gear double clutch transmission according to the invention;

FIG. 18 a shift pattern of the ninth variant embodiment according to FIG. 17;

FIG. 19 a schematic view of a tenth variant embodiment of the nine-gear double clutch transmission according to the invention.

FIG. 20 a shift pattern of the tenth variant embodiment according to FIG. 19;

FIG. 21 a schematic view of an eleventh variant embodiment of the nine-gear double clutch transmission according to the invention;

FIG. 22 a shift pattern of the eleventh variant embodiment according to FIG. 21;

FIG. 23 a schematic view of a twelfth variant embodiment of the nine-gear double clutch transmission according to the invention; and

FIG. 24 a shift pattern of the twelfth variant embodiment according to FIG. 23.

### DETAILED DESCRIPTION OF THE PREFERRED EMBODIMENTS

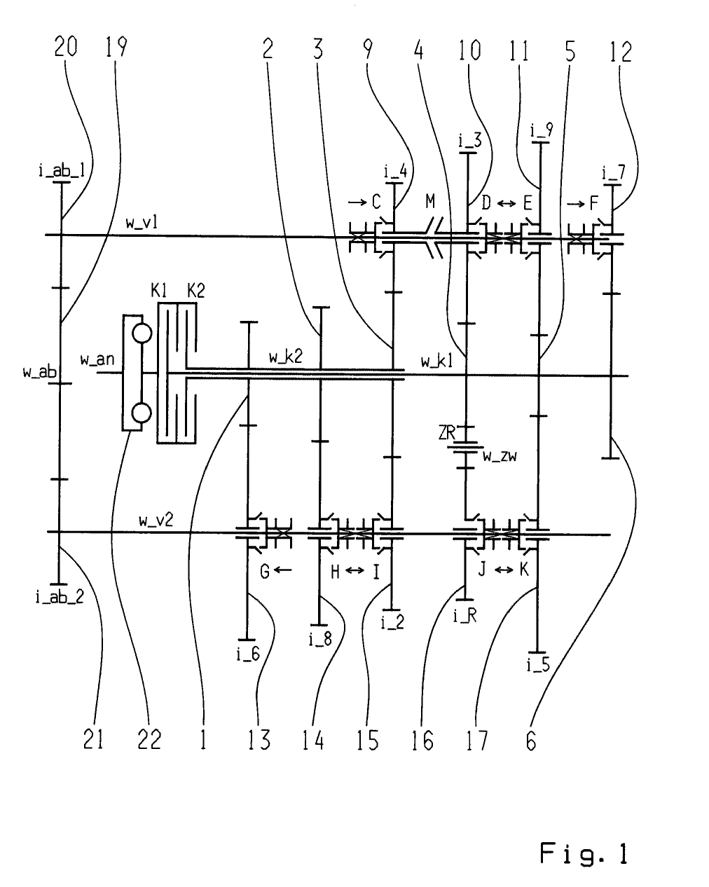

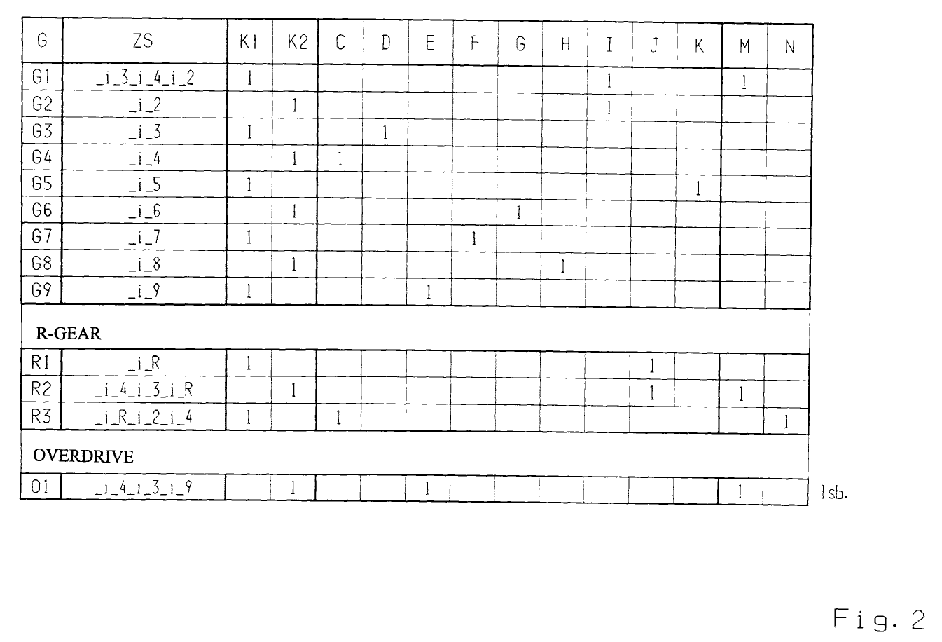

FIGS. 1, 3, 5, 7, 9, 11, 13, 15, 17, 19, 21 and 23 each show a possible variant embodiment of a nine-gear double clutch transmission. The respective shift patterns for the variant embodiments are illustrated in tabular format in FIGS. 2, 4, 6, 8, 10, 12, 14, 16, 18, 20, 22 and 24.

The nine-gear double clutch transmission comprises two clutches K1, K2, the input sides of which are connected to a driveshaft w_an, and the respective output sides of which are connected to one of two transmission input shafts w_k1, w_k2 that are disposed coaxially to each other. Furthermore, a torsion vibration damper 22 may be disposed on the driveshaft w_an. Further, two countershafts w_v1, w_v2 are provided, on which toothed gearwheels embodied as idler gears 7, 8, 9, 10, 11, 12, 13, 14, 15, 16, 17, 18 are rotationally disposed. Toothed gearwheels embodied as fixed gears 1, 2, 3, 4, 5, 6 are disposed on both transmission input shafts w_k1, w_k2 in a rotationally fixed manner, which engage with at least some of the idler gears 7, 8, 9, 10, 11, 12, 13, 14, 15, 16, 17, 18.

In order to be able to connect the idler gears 7, 8, 9, 10, 11, 12, 13, 14, 15, 16, 17, 18 to the respective countershaft w_v1, w_v2, a plurality of actuatable coupling devices A, B, C, D, E, F, G, H, I, J, K, L are provided on the countershafts w_v1, w_v2. Furthermore, output gears 20, 21 are disposed on the countershafts w_v1, w_v2 as constant pinions, which are each coupled to a gearing of a fixed gear 19 of an output shaft w_ab.

In addition to the coupling devices A, B, C, D, E, F, G, H, I, J, K, L which realize a rotationally fixed connection between a toothed gearwheel and the associated countershaft w_v1, w_v2 at least one winding path gear shift element M, N is provided in the double clutch transmission for the rotationally fixed connection of two toothed gearwheels of one countershaft w_v1, w_v2 such that at least one winding path gear is realized.

According to the invention only six gear planes are provided in the double clutch transmission, wherein in each variant embodiment at least three dual gear planes 7-13, 8-14, 9-15, 10-16, 11-17, and a maximum of three single gear planes 1-13, 2-14, 10-4, 12-6, 6-18 are provided such that a total of six gear planes are realized. In this manner at least one power shifting winding path gear can be shifted via at least one actuated shift element M, N. As the shift element M, N, a jaw or the like may be utilized for connecting two toothed gears or the like.

In all variant embodiments of the invention the shift element M is disposed on the first countershaft w_v1 in order to connect the idler gear 9 to the idler gear 10 when the shift element M is actuated. Additionally, in all variant embodiments with the exception of the second to the fourth variant embodiments, one shift element N may be provided on the second countershaft w_v2 to realize further winding path gears. The idler gears 15 and 16 may be connected to each other in a rotationally fixed manner using the actuated shift element.

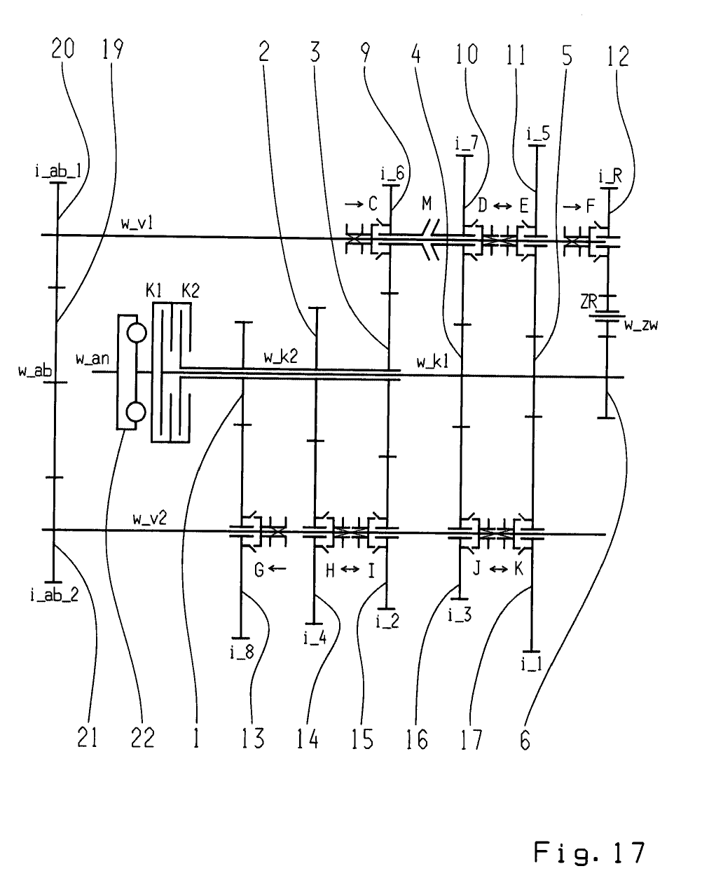

In the first, second, third, fifth, sixth, seventh, eighth, and ninth variant embodiments according to FIGS. 1, 3, 5, 9, 11, 13, 15, and 17, the fixed gear 1 of the second transmission input shaft w_k2 meshes in the first gear plane designed as a single gear plane 1-13 with the idler gear 13 of the second countershaft w_v2. In the second gear plane designed as a single gear plane 2-14, the fixed gear 2 is engaged in the idler gear 14 of the second countershaft w_v2. In the third gear plane 9-15 as the dual gear plane, the fixed gear 3 of the second transmission input shaft w_k2 is engaged both in the idler gear 15 of the second countershaft w_v2 and in the idler gear 9 of the first countershaft w_v1. In the mentioned variant embodiments, with the exception of the ninth variant embodiment according to FIG. 17, the fixed gear 4 of the first transmission input shaft w_k1 is engaged both with the idler gear 10 of the first countershaft w_v1 and in the intermediate gear ZR of an intermediate shaft w_zw for the reversal of rotation for realizing reverse gear transmission ratios. The intermediate gear ZR further meshes with the idler gear 16 of the second countershaft w_v2.

In the ninth variant embodiment the fixed gear 4 engages both the idler gear 10 of the first countershaft w_v1 and the idler gear 16 of the second countershaft w_v2.

Furthermore, in the first, second, third, fifth, sixth, seventh, eighth, and ninth variant embodiment according to FIGS. 1, 3, 5, 9, 11, 13, 15, and 17, the fixed gear 5 of the first transmission input shaft w_k1 meshes in the fifth gear plane 11-17 as the dual gear plane both with the idler gear 11 of the first countershaft w_v1 and with the idler gear 17 of the second countershaft w_v2.

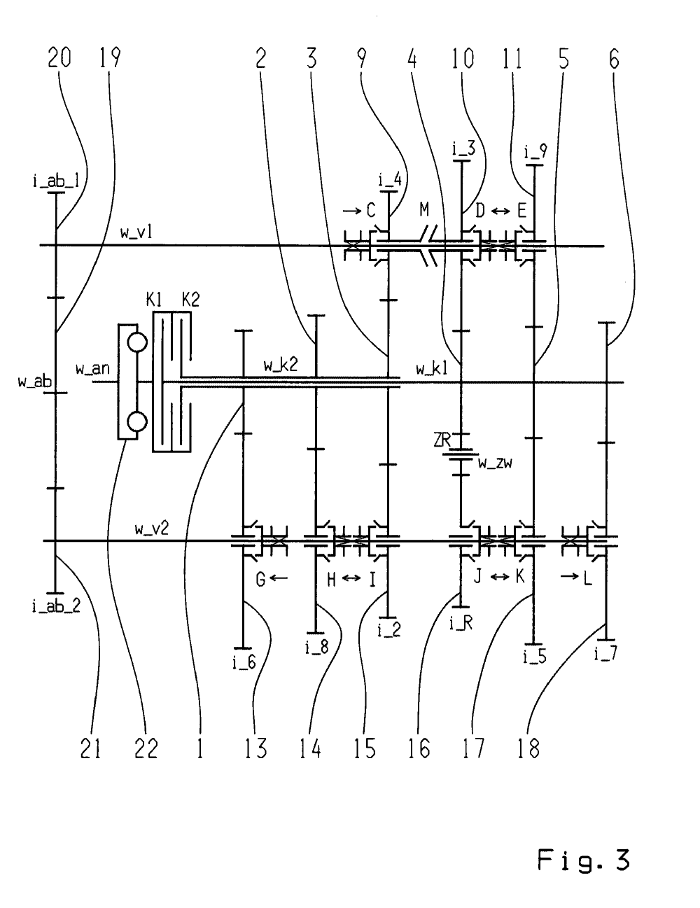

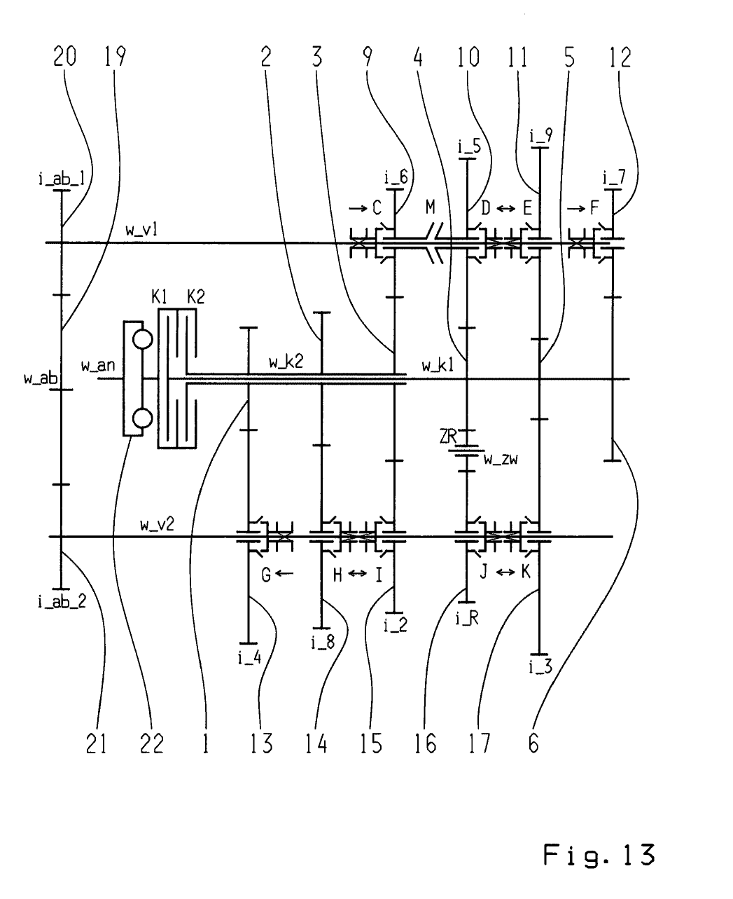

Finally, in the sixth gear plane 12-6 designed as the single gear plane in the first and the seventh variant embodiments according to FIGS. 1 and 13 the fixed gear 6 of the first transmission input shaft w_k1 meshes with the idler gear 12 of the first countershaft w_v1. In the second, third, fifth, sixth, and eighth variant embodiments according to FIGS. 3, 5, 9, 11, and 15 the fixed gear 6 of the first transmission input shaft w_k1 is engaged with the idler gear 18 of the second countershaft w_v2 in the sixth gear plane 6-18 designed as the single gear plane. In the ninth variant embodiment according to FIG. 17 the fixed gear 6 of the first transmission input shaft w_k1 is engaged with an intermediate gear ZR of an intermediate shaft w_zw in the sixth gear plane 12-6 designed as a single gear plane. The intermediate gear ZR is further engaged with the idler gear 12 of the first countershaft w_v1.

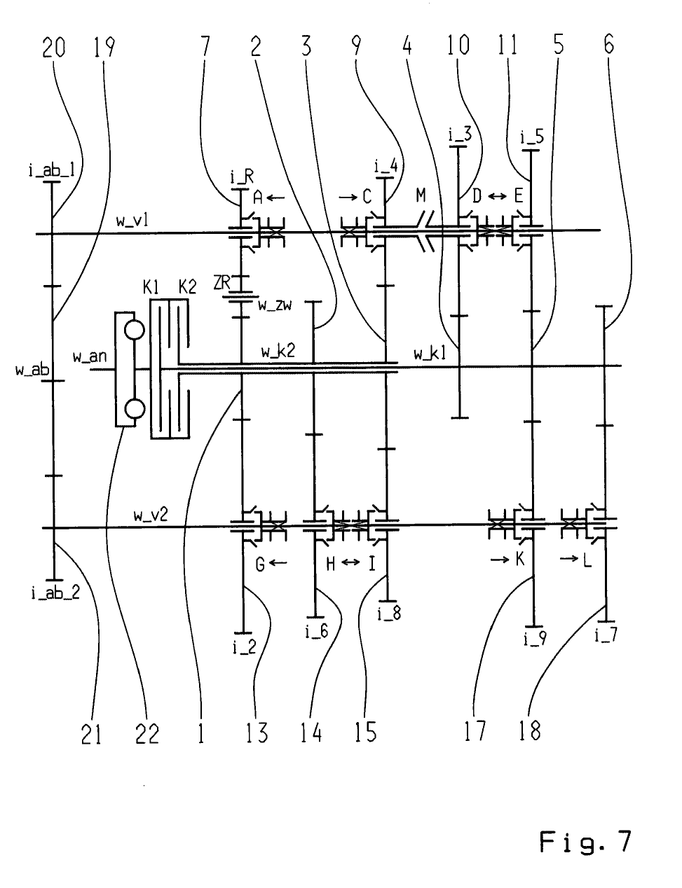

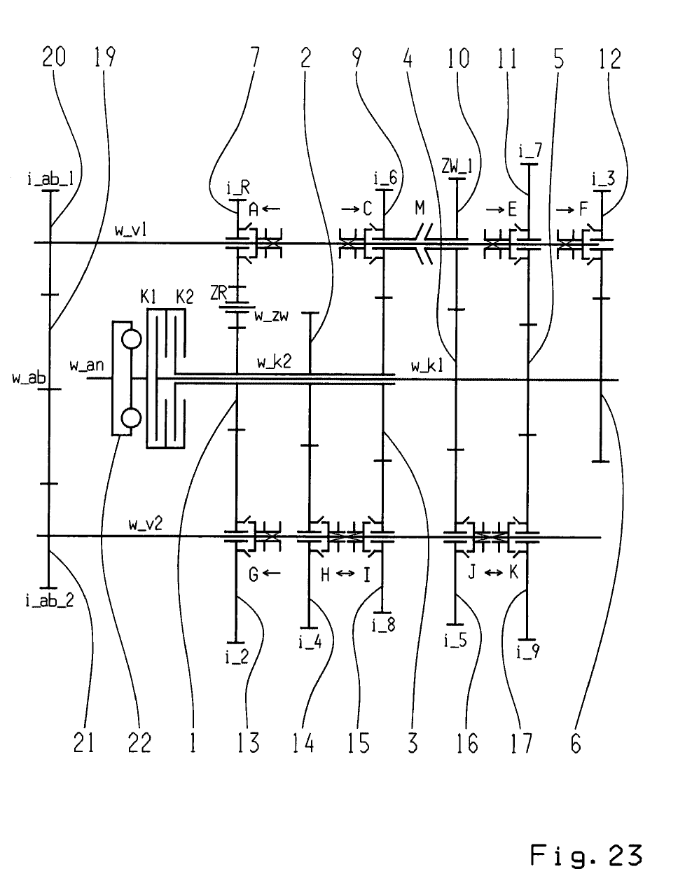

In the fourth and twelfth variant embodiments according to FIGS. 7 and 23 the fixed gear 1 of the second transmission input shaft w_k2 meshes in the first gear plane 7-13 designed as the dual gear plane both with the idler gear 13 of the second countershaft w_v2 and with the intermediate gear ZR of the intermediate shaft w_zw for realizing reverse gear transmission ratios. In the second gear plane 2-14 designed as the single gear plane the fixed gear 2 of the second transmission input shaft w_k2 meshes with the idler gear 14 of the second countershaft w_v2. In the third gear plane 9-15 designed as the dual gear plane the fixed gear plane 3 of the second transmission input shaft w_k2 is engaged with both the idler gear 9 of the first countershaft w_v1 and the idler gear 15 of the second countershaft w_v2.

Furthermore, in the fourth variant embodiment according to FIG. 7, the fixed gear 4 of the first transmission input shaft w_k1 meshes with the fourth gear plane 10-4 with the idler gear 10 of the first countershaft w_v1. In contrast the fixed gear 4 of the first transmission input shaft w_k1 is engaged in the twelfth variant embodiment according to FIG. 23 with both the idler gear 10 of the first countershaft w_v1 and the idler gear 16 of the second countershaft w_v2.

In the fourth and twelfth variant embodiments according to FIGS. 7 and 23 the fixed gear 5 of the first transmission input shaft w_k1 meshes in the fifth gear plane 11-17 designed as the dual gear plane both with the idler gear 11 of the first countershaft w_v1 and with the idler gear 17 of the second countershaft w_v2.

Finally, in the sixth gear plane 6-18 designed as the single gear plane the fixed gear 6 of the first transmission input shaft w_k1 meshes in the fourth variant embodiment with the idler gear 18 of the second countershaft w_v2. In contrast the fixed gear 6 of the first transmission input shaft w_k1 meshes in the twelfth variant embodiment with the idler gear 12 of the first countershaft w_v1.

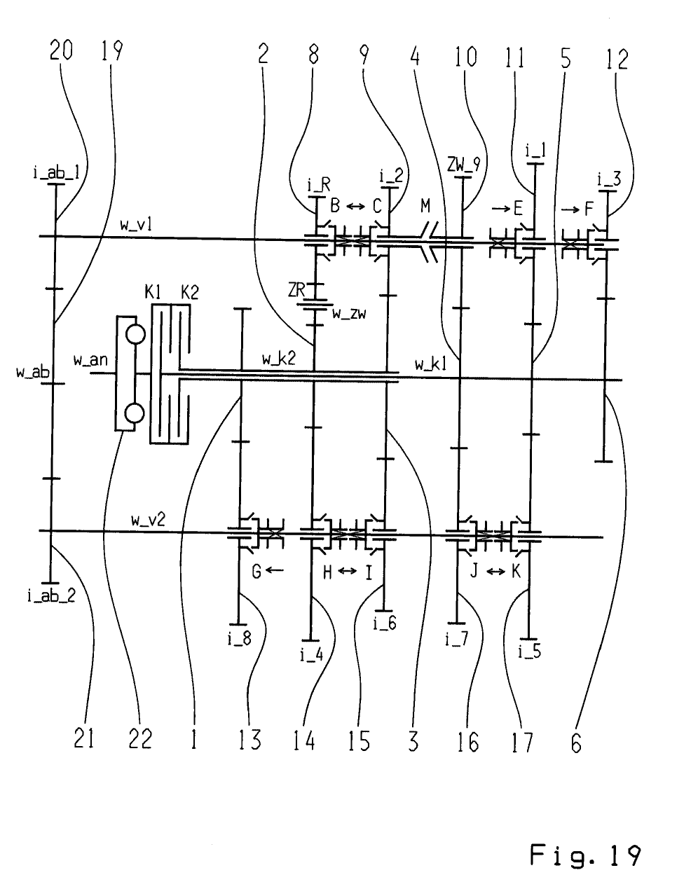

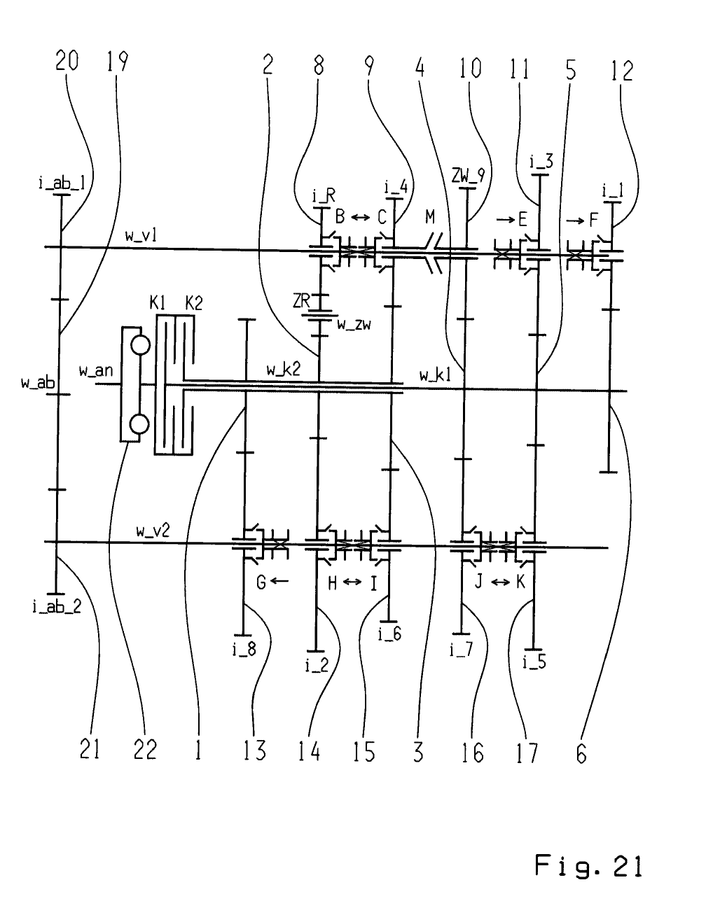

In the tenth and eleventh variant embodiments according to FIGS. 19 and 21, the fixed gear 1 of the second transmission input shaft w_k2 meshes in the first gear plane 1-13 designed as the single gear plane with the idler gear 13 of the second countershaft w_v2. In the second gear plane 8-14 designed as the dual gear plane the fixed gear 2 of the second transmission input shaft w_k2 is engaged both in the idler gear 14 of the second countershaft w_v2 and in the intermediate gear ZR at the intermediate shaft w_zw for the reverse gear transmission ratio. The intermediate gear ZR is further engaged in the idler gear 8 of the first countershaft w_v1. In the third gear plane 9-15 designed as the dual gear plane the fixed gear 3 of the second transmission input shaft w_k2 meshes both with the idler gear 9 of the first countershaft w_v1 and with the idler gear 15 of the second countershaft w_v2. In the fourth gear plane 10-16 designed as the dual gear plane the fixed gear 4 of the first transmission input shaft w_k1 is engaged with both the idler gear 10 of the first countershaft w_v1 and the idler gear 16 of the second countershaft w_v2. In the fifth gear plane 11-17 designed as the dual gear plane the fixed gear 5 of the first transmission input shaft w_k1 meshes both with the idler gear 11 of the first countershaft w_v1 and with the idler gear 17 of the second countershaft w_v2. Finally, the fixed gear 6 of the first transmission input shaft w_k1 is engaged within the sixth gear plane 12-6 as the single gear plane in the fixed gear 12 of the first countershaft w_v1.

In all variant embodiments a unidirectionally operative coupling device G is provided on the second countershaft w_v2 between the first gear plane 1-13 and the second gear plane 2-14 or 8-14. Furthermore, a bidirectionally operative coupling device H-I is provided on the second countershaft w_v2 between the second gear plane 2-14 or 8-14 and the third gear plane 9-15. On the second countershaft w_v2 the idler gear 13 is firmly connected via the coupling device G, and the idler gear 14 is firmly connected via the coupling device H, and the idler gear 15 is firmly connected via the coupling device I to the second countershaft w_v2, if the respective coupling device G, H, I is actuated.

In the first, second, third, fifth, sixth, seventh, eighth, and ninth variant embodiments, a unidirectionally operative coupling device C is associated with the third gear plane 9-15, which firmly connects the idler gear 9 to the first countershaft w_v1 in the actuated state. A bidirectionally operative coupling device D-E or J-K is associated with the first countershaft w_v1 and the second countershaft w_v2 between the fourth gear plane 10-16 and the fifth gear plane 11-17. If the coupling device D is actuated, the idler gear 10 is firmly connected, and if the coupling device E is actuated, the idler gear 11 is firmly connected to the first countershaft w_v1. If the coupling device J is actuated, the idler gear 16 is firmly connected, and if the coupling device K is actuated, the idler gear 17 is firmly connected to the second countershaft w_v2. Finally, a unidirectionally operative coupling device F or L is associated with the sixth gear plane 12-6 or 6-18. The idler gear 12 can be firmly connected to the first countershaft w_v1 using the coupling device F, if the same is actuated. The idler gear 18 can be firmly connected to the second countershaft w_v2 using the coupling device L, if the coupling device L is actuated.

In the tenth and eleventh variant embodiments a bidirectionally operative coupling device B-C is associated between the third gear plane 8-14 and the fourth gear plane 9-15 of the first countershaft w_v1. The idler gear 8 may be firmly connected to the first countershaft w_v1 with the actuated coupling device B, and the idler gear 9 may be firmly connected to the same with the actuated coupling device C. A unidirectionally operative coupling device E is associated with the first prevalent countershaft w_v1, and a bidirectionally operative coupling device J-K is associated with the second countershaft w_v2 between the fourth gear plane 10-16 and the fifth gear plane 11-17. The idler gear 11 may be firmly connected to the first countershaft w_v1 with the actuated coupling device E. The idler gear 16 may be firmly connected to the second countershaft w_v2 with the actuated coupling device J, and the idler gear 17 may be firmly connected to the same with the actuated coupling device K. Finally, a unidirectionally operative coupling device F is associated with the sixth gear plane 12-6, which firmly connects the idler gear 12 to the first countershaft w_v1 in the actuated state.

In the fourth and twelfth variant embodiments a unidirectionally operative coupling device A is associated with the first gear plane 7-13, by means of which the idler gear 7 is firmly connected to the first countershaft w_v1 in the actuated state. Furthermore, a unidirectionally operative coupling device C is associated with the third gear plane 9-15, which firmly connects the idler gear 9 to the first countershaft w_v1 in the actuated state.

In the fourth variant embodiment a bidirectionally operative coupling device D-E is associated between the fourth gear plane 10-4 and the fifth gear plane 11-17, wherein the actuated coupling device D firmly connects the idler gear 10, and the actuated coupling device E firmly connects the idler gear 11 to the first countershaft w_v1. Furthermore, a unidirectionally operative coupling device K is associated with the fifth gear plane 11-17, by means of which the idler gear 17 is firmly connected to the second countershaft w_v2 in the actuated state. Furthermore, a unidirectionally operative coupling device L is associated with the sixth gear plane, wherein the same firmly connects the idler gear 18 to the second countershaft w_v2 in the actuated state.

In contrast, in the twelfth variant embodiment a bidirectionally operative coupling device J-K is provided between the fourth gear plane 10-16 and the fifth gear plane 11-17, wherein the actuated coupling device J firmly connects the idler gear 16, and the actuated coupling device K firmly connects the idler gear 17 to the second countershaft w_v2. Also, a unidirectionally operative coupling device E is associated with the fifth gear plane 11-17, by means of which the idler gear 11 is firmly connected to the first countershaft w_v1 in the actuated state. Finally, a unidirectionally operative coupling device F is associated with the sixth gear plane 12-6, wherein the idler gear 12 is firmly connected to the first countershaft w_v1 in the actuated state.

In the double clutch transmission according to the invention an integrated output stage may be provided together with the output gear 20, which is firmly connected to the first countershaft w_v1, and together with the output gear 21, which is disposed on the second countershaft w_v2. The output gear 20 and the output gear 21 each mesh with a fixed gear 19 of the output shaft w_ab. However, it is also possible that a shiftable connection is realized between the output gear 20 or 21 and the associated countershaft w_v1 or w_v2.

Regardless of the respective variant embodiments the double clutch transmission according to the invention is such that at least the forward gears G1 to G9 may be configured in a power shifting manner. Depending on the variant embodiment, reverse gears and/or crawler gears and/or overdrive gears may also be embodied in a power shifting manner, for example, as winding path gears. Details on each variant embodiment are contained in the shift patterns described as follows.

The table illustrated in FIG. 2 shows a shift pattern for the first variant embodiment of the nine-gear double clutch transmission according to FIG. 1 by way of example.

It is obvious from the shift pattern that the first forward gear G1 may be shifted via the first clutch K1 and via the actuated coupling device I as well as via the actuated shift element M as the winding path gear, that the second forward gear G2 may be shifted via the second clutch K2 and via the actuated coupling device I, that the third forward gear G3 may be shifted via the first clutch K1 and via the actuated coupling device D, that the fourth forward gear G4 may be shifted via the second clutch K2 and via the actuated coupling device C, that the fifth forward gear G5 may be shifted via the first clutch K1 and via the actuated coupling device K, that the sixth forward gear G6 may be shifted via the second clutch K2 and via the actuated coupling device G, that the seventh forward gear G7 may be shifted via the first clutch K1 and via the actuated coupling device F, that the eighth forward gear G8 may be shifted via the second clutch K2 and via the actuated coupling device H, and that the ninth forward gear G9 may be shifted via the first clutch K1 and via the actuated coupling device E.

In the first variant embodiment it is further obvious from the table illustrated in FIG. 2 that a reverse gear R1 may be shifted via the first clutch K1 and via the actuated coupling device J. A subsequent reverse gear R2 may be shifted via the second clutch K2 and via the actuated coupling device J and via the actuated shift element M as the winding path gear. Furthermore, for example, a further reverse gear R3 may be shifted via the first clutch K1 and via the actuated coupling device C and via an actuated shift element N as the winding path gear. Advantageously, the reverse gear R2 as the winding path gear may be configured in a power shifting manner to the first reverse gear R1.

Furthermore, an overdrive gear O1 may be shifted via the second clutch K2, via the actuated coupling device E, and via the actuated shift element M as the winding path gear in the double clutch transmission provided according to the first variant embodiment. Advantageously, shifting may be carried out under load, e.g. without any traction force interruption, between the overdrive gear O1 and the ninth forward gear G9.

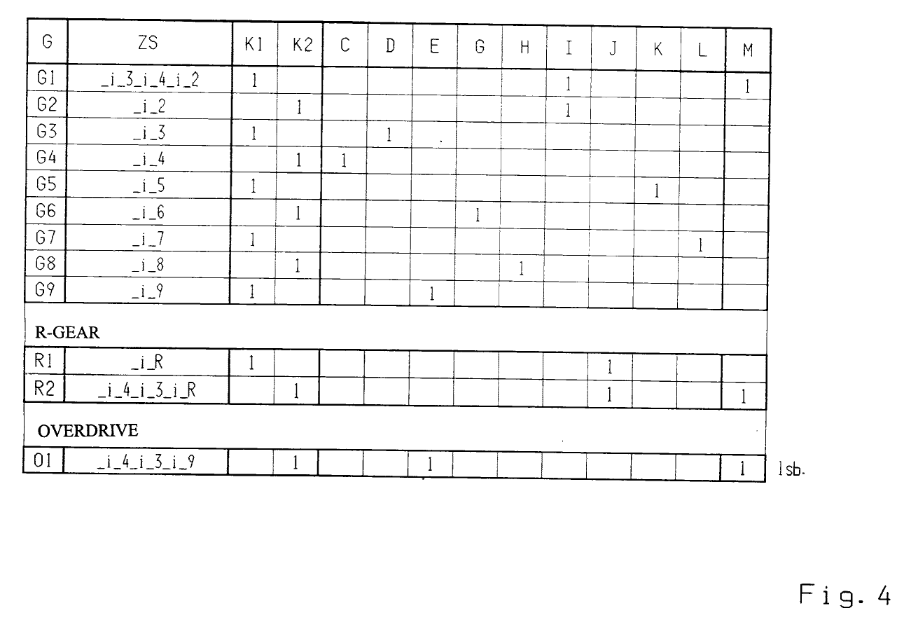

The table illustrated in FIG. 4 shows a shift pattern for the second variant embodiment of the nine-gear double clutch transmission according to FIG. 3 by way of example.

The shift pattern shows that the first forward gear G1 may be shifted via the first clutch K1 and via the actuated coupling device I as well as via the actuated shift element M as the winding path gear, that the second forward gear G2 may be shifted via the second clutch K2 and via the actuated coupling device I, that the third forward gear G3 may be shifted via the first clutch K1 and via the actuated coupling device D, that the fourth forward gear G4 may be shifted via the second clutch K2 and via the actuated coupling device C, that the fifth forward gear G5 may be shifted via the first clutch K1 and via the actuated coupling device K, that the sixth forward gear G6 may be shifted via the second clutch K2 and via the actuated coupling device G, that the seventh forward gear G7 may be shifted via the first clutch K1 and via the actuated coupling device L, that the eighth forward gear G8 may be shifted via the second clutch K2 and via the actuated coupling device H, and that the ninth forward gear G9 may be carried out via the first clutch K1 and via the actuated coupling device E.

In the second variant embodiment it is further obvious from the table illustrated in FIG. 4 that a reverse gear R1 may be shifted via the first clutch K1 and via the actuated coupling device J. Furthermore, a further reverse gear R2 may be shifted, for example, via the second clutch K2 and via the actuated coupling device J as well as via the actuated shift element M as the winding path gear. In a preferred manner the reverse gear R2 may be configured in a power shifting manner to the first reverse gear R1.

Furthermore, an overdrive gear O1 may be shifted via the second clutch K2 and via the actuated coupling device E as well as via the actuated shift element M as the winding path gear. The overdrive gear O1 may be configured, for example, in a power shifting manner to the ninth forward gear G9.

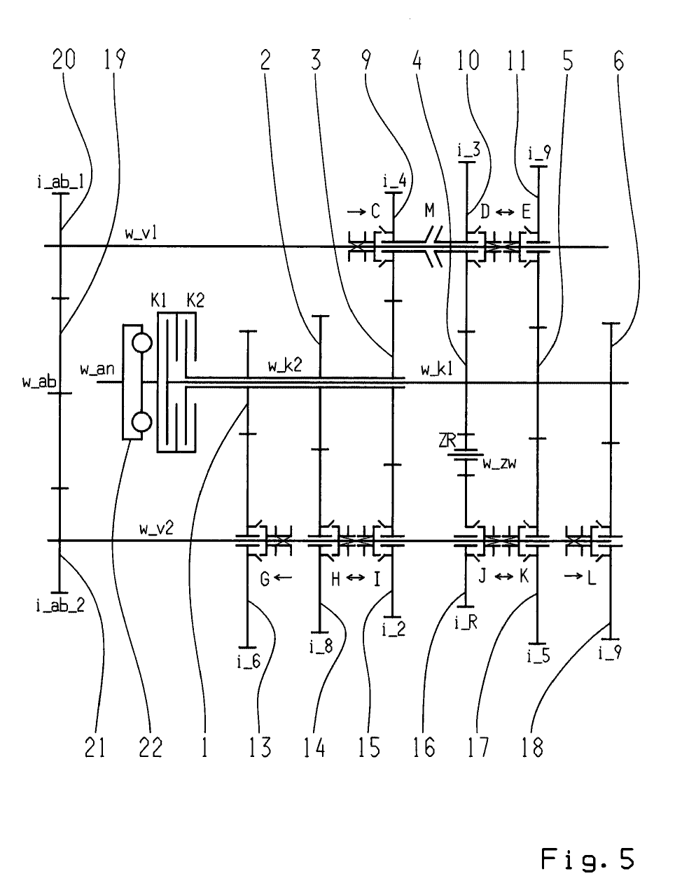

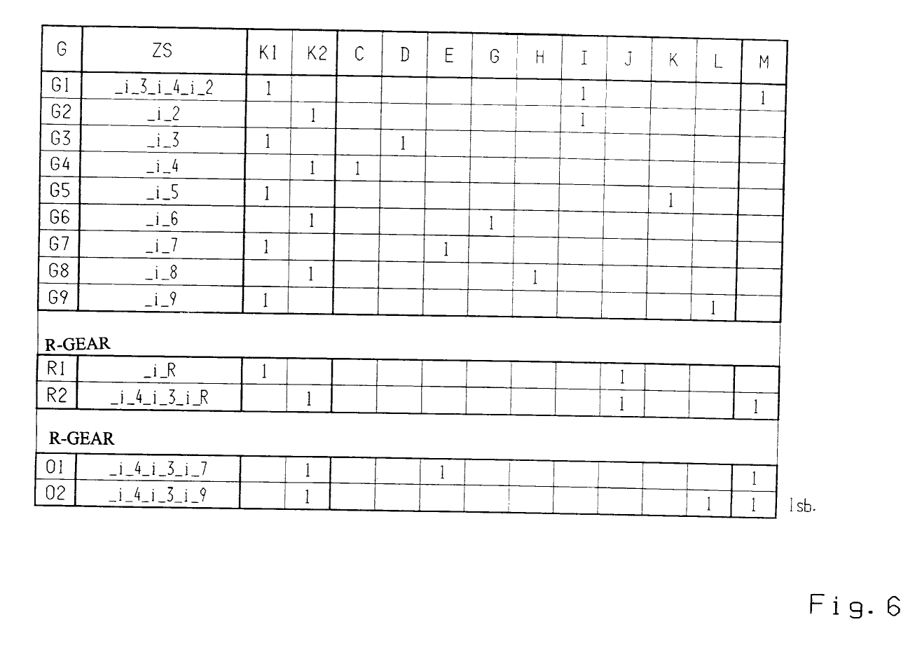

The table illustrated in FIG. 6 shows a shift pattern for the third variant embodiment of the nine-gear double clutch transmission according to FIG. 5 by way of example.

The shift pattern shows that the first forward gear G1 may be shifted via the first clutch K1 and via the actuated coupling device I as well as via the actuated shift element M as the winding path gear, that the second forward gear G2 may be shifted via the second clutch K2 and via the actuated coupling device I, that the third forward gear G3 may be shifted via the first clutch K1 and via the actuated coupling device D, that the fourth forward gear G4 may be shifted via the second clutch K2 and via the actuated coupling device C, that the fifth forward gear G5 may be shifted via the first clutch K1 and via the actuated coupling device K, that the sixth forward gear G6 may be shifted via the second clutch K2 and via the actuated coupling device G, that the seventh forward gear G7 may be shifted via the first clutch K1 and via the actuated coupling device E, that the eighth forward gear G8 may be shifted via the second clutch K2 and via the actuated coupling device H, and that the ninth forward gear G9 may be carried out via the first clutch K1 and via the actuated coupling device L.

In the third variant embodiment it is further obvious from the table illustrated in FIG. 6 that a reverse gear R1 may be shifted via the first clutch K1 and via the actuated coupling device J. Furthermore, a further reverse gear R2 may be shifted, for example, via the second clutch K2 and via the actuated coupling device J as well as via the actuated shift element M as the winding path gear. The reverse gear R2 may be configured, for example, in a power shifting manner to the first reverse gear R1.

Furthermore, an overdrive gear O1 may be shifted via the second clutch K2 and via the actuated coupling device E as well as via the actuated shift element M as the winding path gear. Furthermore, an additional overdrive gear O2 may be carried out via the second clutch K2 and via the actuated coupling device L and via the actuated shift element M. The overdrive gear O2 may be configured in a power shifting manner from the ninth forward gear G9.

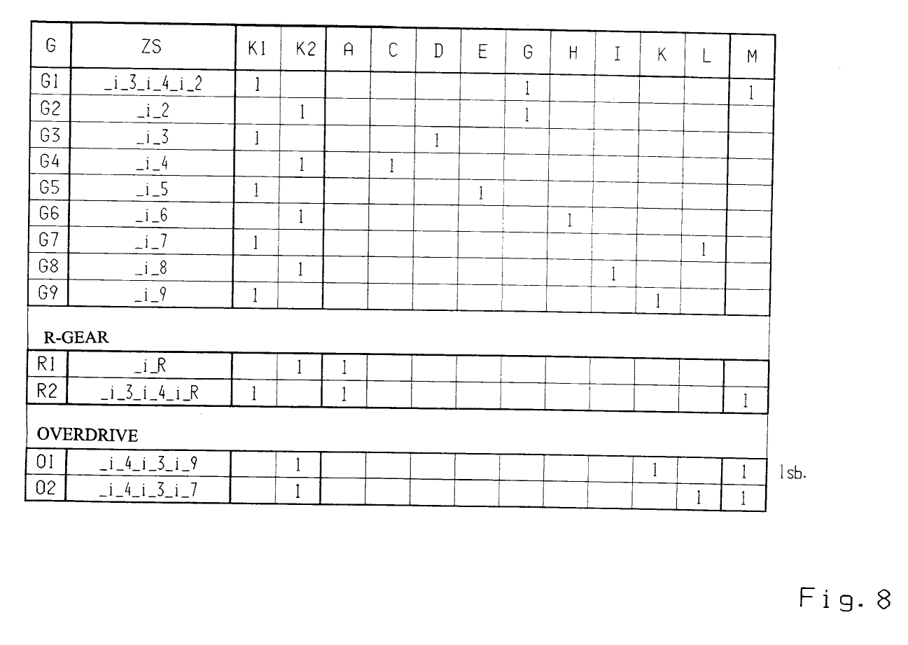

The table illustrated in FIG. 8 shows a shift pattern for the fourth variant embodiment of the nine-gear double clutch transmission according to FIG. 7 by way of example.

The shift pattern shows that the first forward gear G1 may be shifted via the first clutch K1 and via the actuated coupling device G as well as via the actuated shift element M as the winding path gear, that the second forward gear G2 may be shifted via the second clutch K2 and via the actuated coupling device G, that the third forward gear G3 may be shifted via the first clutch K1 and via the actuated coupling device D, that the fourth forward gear G4 may be shifted via the second clutch K2 and via the actuated coupling device C, that the fifth forward gear G5 may be shifted via the first clutch K1 and via the actuated coupling device E, that the sixth forward gear G6 may be shifted via the second clutch K2 and via the actuated coupling device H, that the seventh forward gear G7 may be shifted via the first clutch K1 and via the actuated coupling device L, that the eighth forward gear G8 may be shifted via the second clutch K2 and via the actuated coupling device I, and that the ninth forward gear G9 may be carried out via the first clutch K1 and via the actuated coupling device K.

In the fourth variant embodiment it is further obvious from the table illustrated in FIG. 8 that a reverse gear R1 may be shifted via the second clutch K2 and via the actuated coupling device A, and/or that a further reverse gear R2 may be shifted via the first clutch K1 and via the actuated coupling device A and via the actuated shift element M as the winding path gear. Advantageously, the reverse gears R1 and R2 may be configured in a power shifting manner to each other.

Furthermore, an overdrive gear O1 may be shifted via the second clutch K2, via the actuated coupling device K and via the actuated shift element M as the winding path gear in the double clutch transmission according to the fourth variant embodiment. Furthermore, an additional overdrive gear O2 may be shifted via the second clutch K2, via the actuated coupling device L and via the actuated shift element M as the winding path gear. The overdrive gear O1 may be configured in a power shifting manner to the ninth forward gear G9.

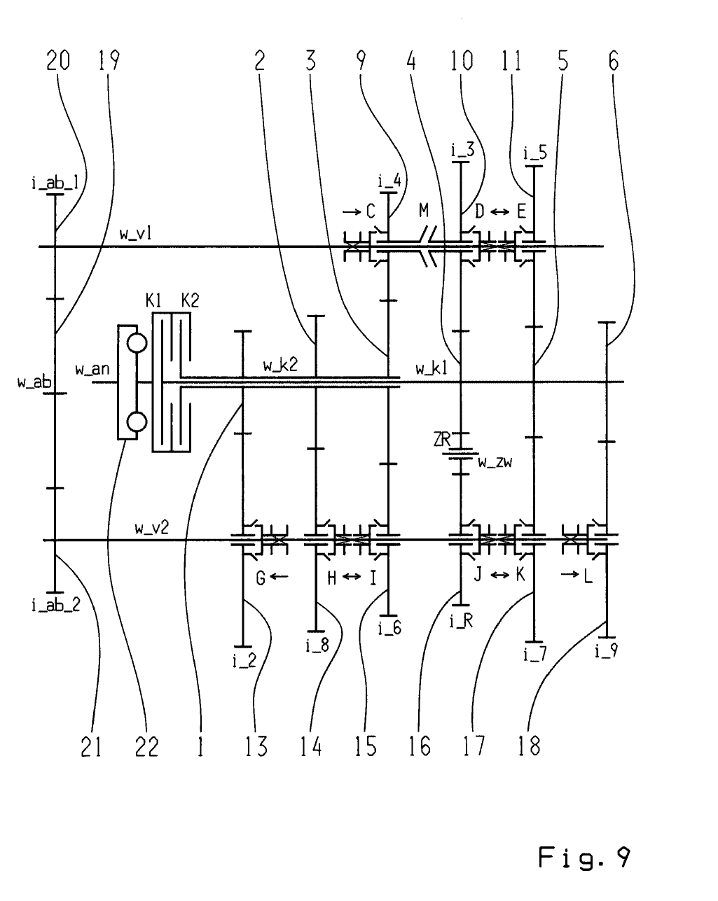

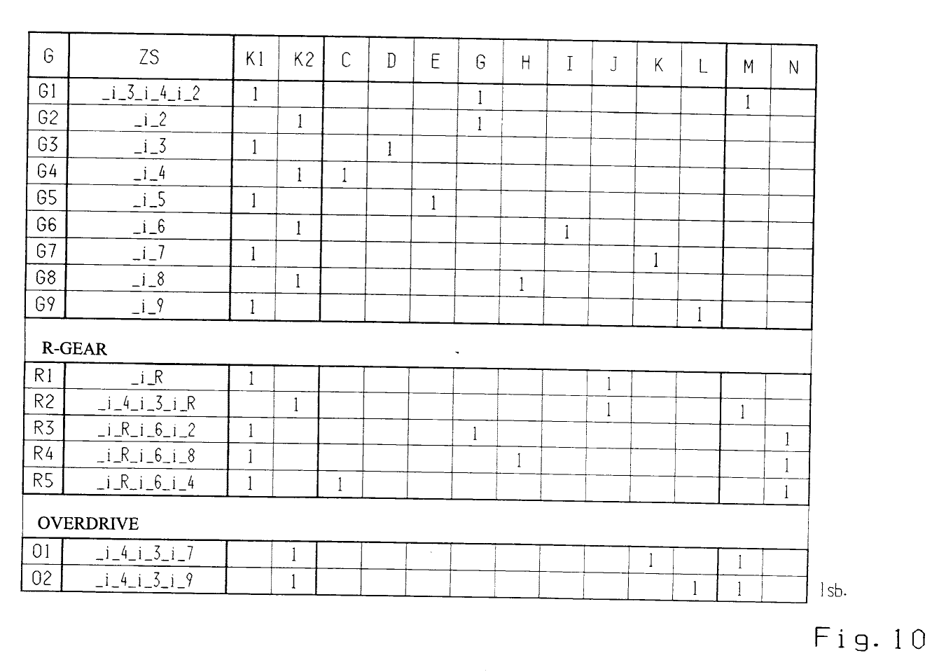

The table illustrated in FIG. 10 shows a shift pattern for the fifth variant embodiment of the nine-gear double clutch transmission according to FIG. 9 by way of example.

The shift pattern shows that the first forward gear G1 may be shifted via the first clutch K1 and via the actuated coupling device G as well as via the actuated shift element M as the winding path gear, that the second forward gear G2 may be shifted via the second clutch K2 and via the actuated coupling device G, that the third forward gear G3 may be shifted via the first clutch K1 and via the actuated coupling device D, that the fourth forward gear G4 may be shifted via the second clutch K2 and via the actuated coupling device C, that the fifth forward gear G5 may be shifted via the first clutch K1 and via the actuated coupling device E, that the sixth forward gear G6 may be shifted via the second clutch K2 and via the actuated coupling device I, that the seventh forward gear G7 may be shifted via the first clutch K1 and via the actuated coupling device K, that the eighth forward gear G8 may be shifted via the second clutch K2 and via the actuated coupling device H, and that the ninth forward gear G9 may be carried out via the first clutch K1 and via the actuated coupling device L.

In the fifth variant embodiment the table illustrated in FIG. 10 also shows that a reverse gear R1 may be shifted via the first clutch K1 and via the actuated coupling device J. Furthermore, a further reverse gear R2 may be shifted via the second clutch K2 and via the actuated coupling device J as well as via the actuated shift element M as the winding path gear. Therefore, the reverse gear R2 and the first reverse gear R1 may be power shifted to each other. Furthermore, a subsequent reverse gear R3 may be shifted via the first clutch K1 and via the actuated coupling device G as well as via the actuated shift element N at the second countershaft w_v2 as the winding path gear. Also, a further reverse gear R4 is shifted via the first clutch K1 and via the actuated coupling device H as well as via the actuated shift element N as the winding path gear. Finally, a subsequent reverse gear R5 may also be shifted via the first clutch K1 and via the actuated coupling device C as well as via the actuated shift element N at the second countershaft w_v2 as the winding path gear.

Furthermore, an overdrive gear O1 can be shifted via the second clutch K2 and via the actuated coupling device K as well as via the actuated shift element M as the winding path gear. Further, an additional overdrive gear O2 may be shifted via the second clutch K2 and via the actuated coupling device L as well as via the actuated shift element M as the winding path gear. The overdrive gear O2 may be configured in a power shifting manner to the ninth forward gear G1.

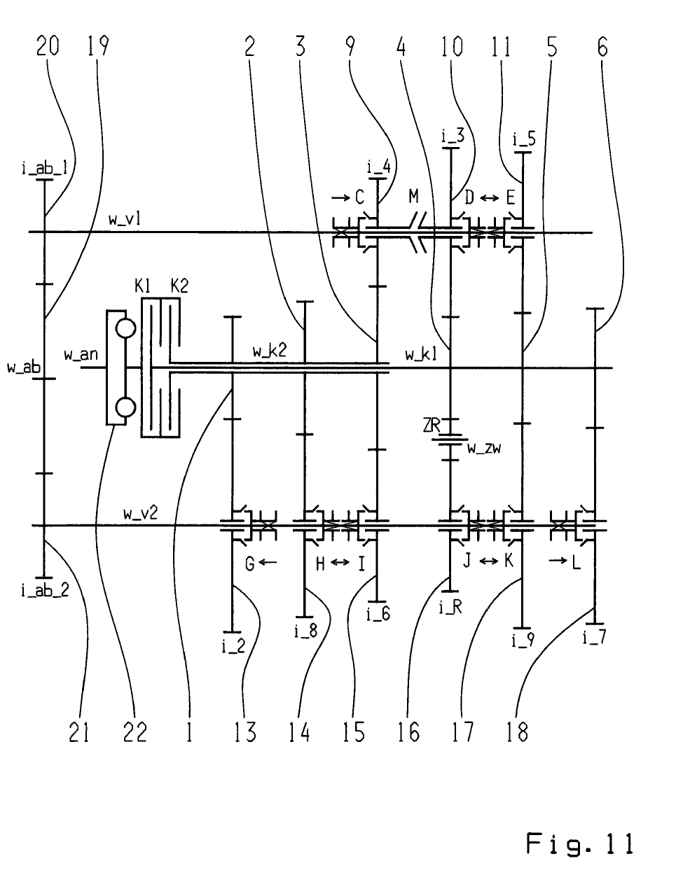

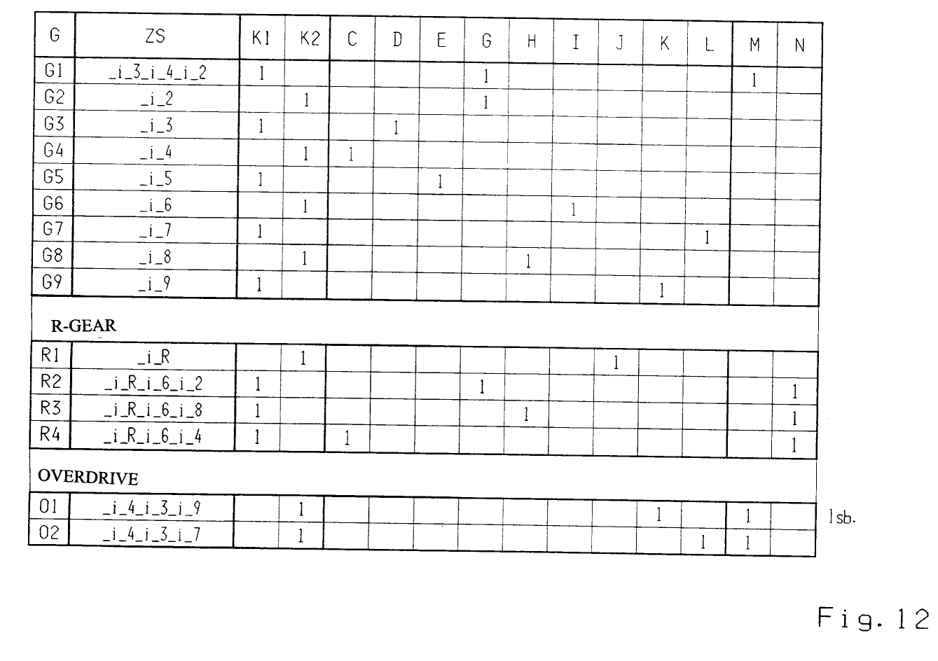

The table illustrated in FIG. 12 shows a shift pattern for the sixth variant embodiment of the nine-gear double clutch transmission according to FIG. 11 by way of example.

The shift pattern shows that the first forward gear G1 may be shifted via the first clutch K1 and via the actuated coupling device G as well as via the actuated shift element M as the winding path gear, that the second forward gear G2 may be shifted via the second clutch K2 and via the actuated coupling device G, that the third forward gear G3 may be shifted via the first clutch K1 and via the actuated coupling device D, that the fourth forward gear G4 may be shifted via the second clutch K2 and via the actuated coupling device C, that the fifth forward gear G5 may be shifted via the first clutch K1 and via the actuated coupling device E, that the sixth forward gear G6 may be shifted via the second clutch K2 and via the actuated coupling device I, that the seventh forward gear G7 may be shifted via the first clutch K1 and via the actuated coupling device L, that the eighth forward gear G8 may be shifted via the second clutch K2 and via the actuated coupling device H, and that the ninth forward gear G9 may be carried out via the first clutch K1 and via the actuated coupling device K.

In the sixth variant embodiment the table illustrated in FIG. 12 also shows that a reverse gear R1 may be shifted via the second clutch K2 and via the actuated coupling device J, and/or that a further reverse gear R2 may be shifted via the first clutch K1 and via the actuated coupling device G as well as via the actuated shift element N as the winding path gear. Furthermore, an additional reverse gear R3 may be shifted via the first clutch K1 and via the actuated coupling device H as well as via the actuated shift element N as the winding path gear. Further, a subsequent reverse gear R4 is shifted via the first clutch K1 and via the actuated coupling device C as well as via the actuated shift element N as the winding path gear.

Furthermore, an overdrive gear O1 may be carried out via the second clutch K2 and via the actuated coupling device K as well as via the actuated shift element M as the winding path gear (O1 (lsb) power shifted to G9). As an alternative, or additionally, a further overdrive gear O2 may be carried out via the second clutch K2 and via the actuated coupling device L as well as via the actuated shift element M as the winding path gear.

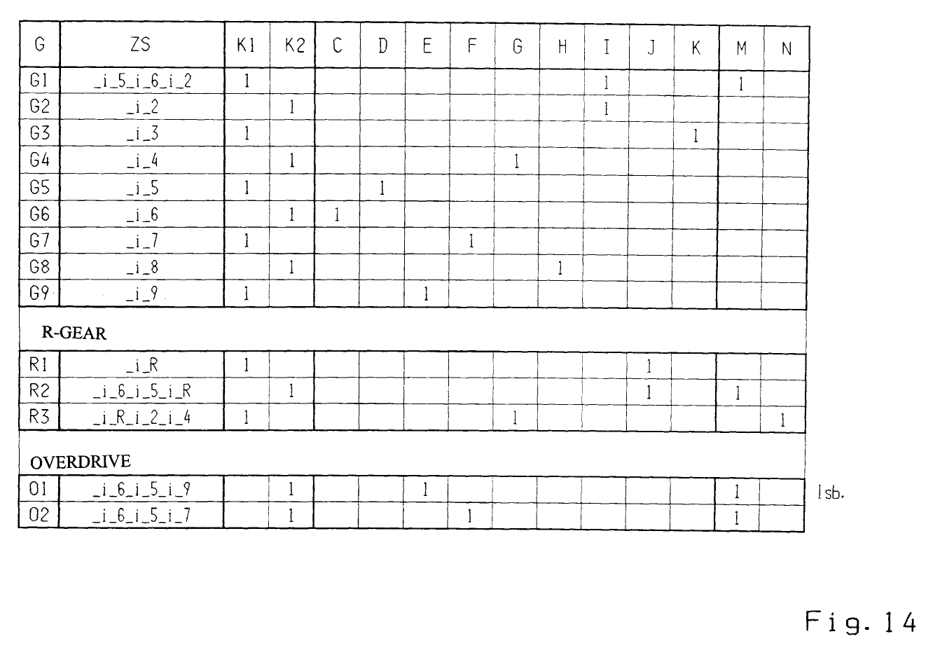

The table illustrated in FIG. 14 shows a shift pattern for the seventh variant embodiment of the nine-gear double clutch transmission according to FIG. 13 by way of example.

The shift pattern shows that the first forward gear G1 may be shifted via the first clutch K1 and via the actuated coupling device I as well as via the actuated shift element M as the winding path gear, that the second forward gear G2 may be shifted via the second clutch K2 and via the actuated coupling device I, that the third forward gear G3 may be shifted via the first clutch K1 and via the actuated coupling device K, that the fourth forward gear G4 may be shifted via the second clutch K2 and via the actuated coupling device G, that the fifth forward gear G5 may be shifted via the first clutch K1 and via the actuated coupling device D, that the sixth forward gear G6 may be shifted via the second clutch K2 and via the actuated coupling device C, that the seventh forward gear G7 may be shifted via the first clutch K1 and via the actuated coupling device F, that the eighth forward gear G8 may be shifted via the second clutch K2 and via the actuated coupling device H, and that the ninth forward gear G9 may be carried out via the first clutch K1 and via the actuated coupling device E.

In the seventh variant embodiment the table illustrated in FIG. 14 shows that a reverse gear R1 may be shifted via the first clutch K1 and via the actuated coupling device J, and/or that a further reverse gear R2 may be shifted via the second clutch K2 and via the actuated coupling device J and via the actuated shift element M as the winding path gear. Furthermore, a subsequent reverse gear R3 may be shifted via the first clutch K1 and via the actuated coupling device G as well as via the actuated shift element N as the winding path gear. The reverse gear R2 may be carried out in a power shifting manner to R1.

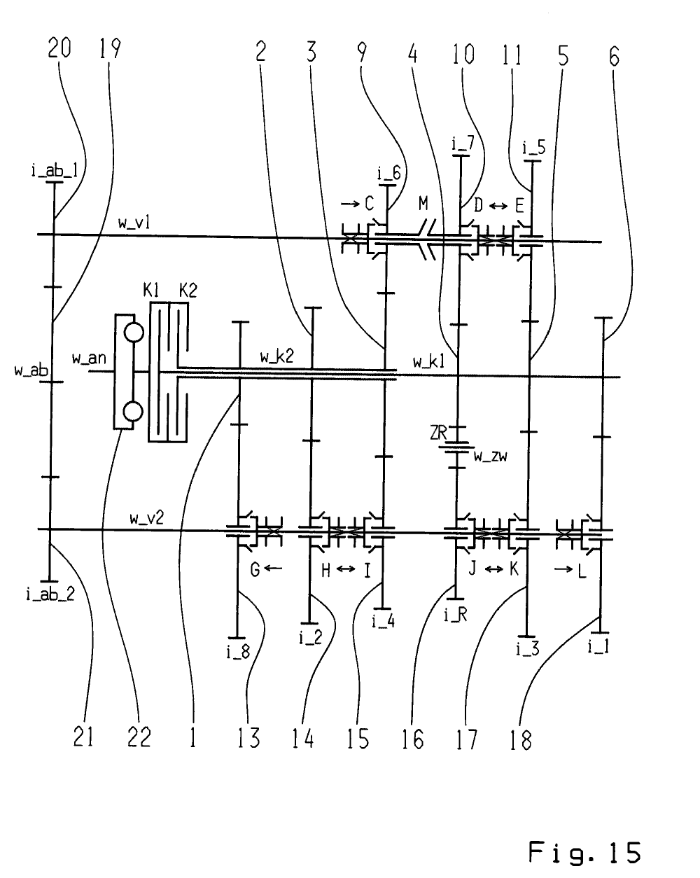

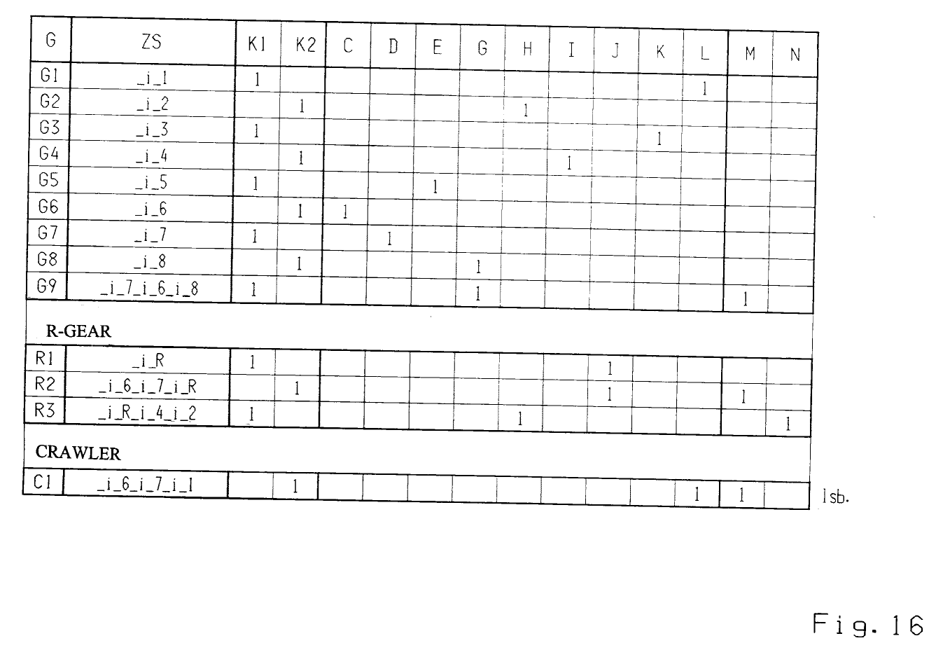

The table illustrated in FIG. 16 shows a shift pattern for the eighth variant embodiment of the nine-gear double clutch transmission according to FIG. 15 by way of example.

The shift pattern shows that the first forward gear G1 may be shifted via the first clutch K1 and via the actuated coupling device L, that the second forward gear G2 may be shifted via the second clutch K2 and via the actuated coupling device H, that the third forward gear G3 may be shifted via the first clutch K1 and via the actuated coupling device K, that the fourth forward gear G4 may be shifted via the second clutch K2 and via the actuated coupling device I, that the fifth forward gear G5 may be shifted via the first clutch K1 and via the actuated coupling device E, that the sixth forward gear G6 may be shifted via the second clutch K2 and via the actuated coupling device C, that the seventh forward gear G7 may be shifted via the first clutch K1 and via the actuated coupling device D, that the eighth forward gear G8 may be shifted via the second clutch K2 and via the actuated coupling device G, and that the ninth forward gear G9 may be carried out via the first clutch K1 and via the actuated coupling device G and via the actuated shift element M as the winding path gear.

In the eighth variant embodiment the table illustrated in FIG. 16 shows that a reverse gear R1 may be shifted via the first clutch K1 and via the actuated coupling device J, and/or that a subsequent reverse gear R2 may be carried out via the second clutch K2 and via the actuated coupling device J as well as via the actuated shift element M as the winding path gear (e.g. R2 (lsb.) power shifted to R1), and/or that a further reverse gear R3 may be carried out via the first clutch K1 and via the actuated coupling device H as well as via the actuated shift element N as the winding path gear. The reverse gear R2 may be power shifted to the reverse gears R1 (e.g. R2 (lsb) power shifted to R1).

Furthermore, a crawler gear C1 may be carried out via the second clutch K2 and via the actuated coupling device L as well as via the actuated shift element M as the winding path gear. The crawler gear C1 may be carried out in a power shifting manner to the first forward gear G1.

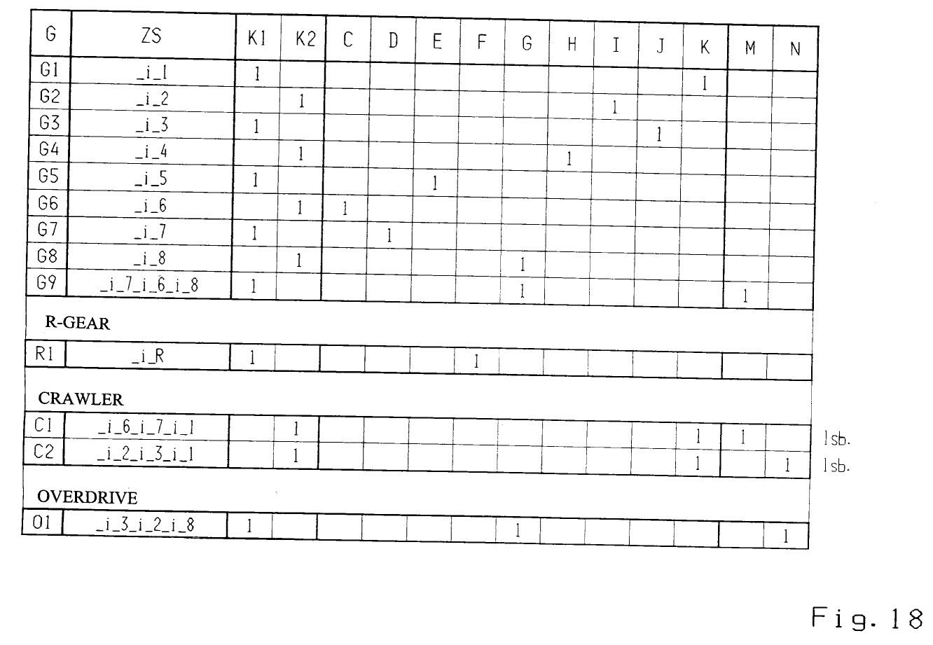

The table illustrated in FIG. 18 shows a shift pattern for the eighth variant embodiment of the nine-gear double clutch transmission according to FIG. 17 by way of example.

The shift pattern shows that the first forward gear G1 may be shifted via the first clutch K1 and via the actuated coupling device K, that the second forward gear G2 may be shifted via the second clutch K2 and via the actuated coupling device I, that the third forward gear G3 may be shifted via the first clutch K1 and via the actuated coupling device J, that the fourth forward gear G4 may be shifted via the second clutch K2 and via the actuated coupling device H, that the fifth forward gear G5 may be shifted via the first clutch K1 and via the actuated coupling device E, that the sixth forward gear G6 may be shifted via the second clutch K2 and via the actuated coupling device C, that the seventh forward gear G7 may be shifted via the first clutch K1 and via the actuated coupling device D, that the eighth forward gear G8 may be shifted via the second clutch K2 and via the actuated coupling device G, and that the ninth forward gear G9 may be carried out via the first clutch K1 and via the actuated coupling device G and via the actuated shift element M as the winding path gear.

In the ninth variant embodiment the table illustrated in FIG. 18 shows that a reverse gear R1 may be shifted via the first clutch K1 and via the actuated coupling device F.

Furthermore, a crawler gear C1 (e.g. C1 (lsb.) power shifted to G1) may be shifted via the second clutch K2 and via the actuated coupling device K as well as via the actuated shift element M as the winding path gear. Further, an additional crawler gear C2 may be shifted via the second clutch K2 and via the actuated coupling device K as well as via the actuated shift element N as the winding path gear, which may also be carried out in a power shifting manner to the first forward gear G1. Furthermore, an overdrive gear O1 may be shifted via the first clutch K1 and via the actuated coupling device G as well as via the actuated shift element N as the winding path gear.

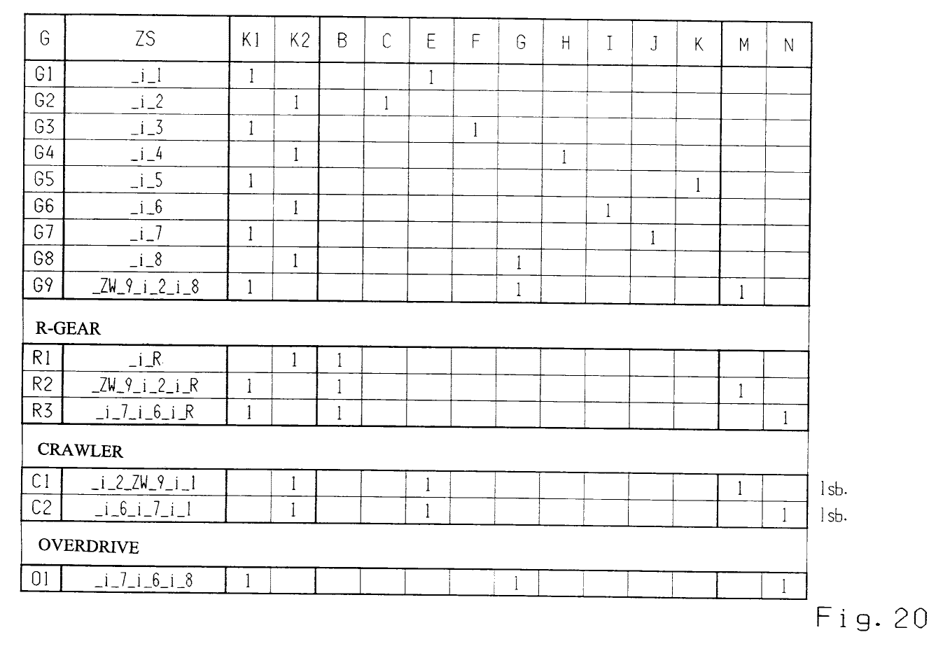

The table illustrated in FIG. 20 shows a shift pattern for the eighth variant embodiment of the nine-gear double clutch transmission according to FIG. 19 by way of example.

The shift pattern shows that the first forward gear G1 may be shifted via the first clutch K1 and via the actuated coupling device E, that the second forward gear G2 may be shifted via the second clutch K2 and via the actuated coupling device C, that the third forward gear G3 may be shifted via the first clutch K1 and via the actuated coupling device F, that the fourth forward gear G4 may be shifted via the second clutch K2 and via the actuated coupling device H, that the fifth forward gear G5 may be shifted via the first clutch K1 and via the actuated coupling device K, that the sixth forward gear G6 may be shifted via the second clutch K2 and via the actuated coupling device I, that the seventh forward gear G7 may be shifted via the first clutch K1 and via the actuated coupling device J, that the eighth forward gear G8 may be shifted via the second clutch K2 and via the actuated coupling device G, and that the ninth forward gear G9 may be carried out via the first clutch K1 and via the actuated coupling device G and via the actuated shift element M as the winding path gear.

In the tenth variant embodiment the table illustrated in FIG. 20 shows that a reverse gear R1 may be shifted via the second clutch K2 and via the actuated coupling device B, and/or that a further reverse gear R2 may be shifted via the first clutch K1 and via the actuated coupling device B and via the actuated shift element M as the winding path gear (e.g. R2 (lsb.) power shifted to R1), and/or that a subsequent reverse gear R3 may be shifted via the first clutch K1 and via the actuated coupling device B and via the actuated shift element N as the winding path gear (R3 (lsb.) power shifted to R1).

Furthermore, a crawler gear C1 (e.g. C1 (lsb.) power shifted to G1) may be shifted via the second clutch K2 and via the actuated coupling device E and via the actuated shift element M as the winding path gear. Also, as an alternative or additionally, a further crawler gear C2 (e.g. C2 (lsb.) power shifted to G1) may also be shifted via the second clutch K2 and via the actuated coupling device E and via the actuated shift element N as the winding path gear. Additionally, an overdrive gear O1 may be shifted via the first clutch K1 and via the actuated coupling device G and via the actuated shift element N as the winding path gear.

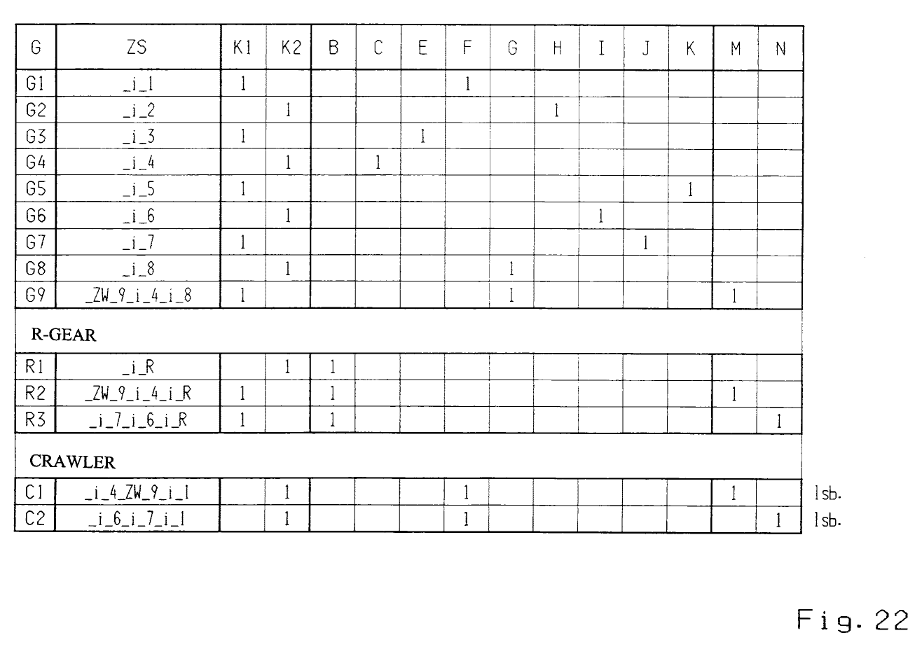

The table illustrated in FIG. 22 shows a shift pattern for the eleventh variant embodiment of the nine-gear double clutch transmission according to FIG. 21 by way of example.

The shift pattern shows that the first forward gear G1 may be shifted via the first clutch K1 and via the actuated coupling device F, that the second forward gear G2 may be shifted via the second clutch K2 and via the actuated coupling device H, that the third forward gear G3 may be shifted via the first clutch K1 and via the actuated coupling device E, that the fourth forward gear G4 may be shifted via the second clutch K2 and via the actuated coupling device C, that the fifth forward gear G5 may be shifted via the first clutch K1 and via the actuated coupling device K, that the sixth forward gear G6 may be shifted via the second clutch K2 and via the actuated coupling device I, that the seventh forward gear G7 may be shifted via the first clutch K1 and via the actuated coupling device J, that the eighth forward gear G8 may be shifted via the second clutch K2 and via the actuated coupling device G, and that the ninth forward gear G9 may be carried out via the first clutch K1 and via the actuated coupling device G and via the actuated shift element M as the winding path gear.

In the eleventh variant embodiment the table illustrated in FIG. 22 shows that a reverse gear R1 may be shifted via the second clutch K2 and via the actuated coupling device B, and/or that a further reverse gear R2 may be shifted via the first clutch K1 and via the actuated coupling device B and via the actuated shift element M as the winding path gear (e.g. R2 (lsb.) power shifted to R1), and/or that a subsequent reverse gear R3 may be shifted via the first clutch K1 and via the actuated coupling device B and via the actuated shift element N as the winding path gear (R3 (lsb.) power shifted to R1). The reverse gear R1 may also be power shifted to the first forward gear G1 (e.g. R1 (lsb.) power shifted to G1).

Furthermore, a crawler gear C1 may be shifted via the second clutch K2 and via the actuated coupling device F and via the actuated shift element M as the winding path gear (e.g. C1 (lsb.) power shifted to G1). Also, as an alternative or additionally, a further crawler gear C2 may also be shifted via the second clutch K2 and via the actuated coupling device F and via the actuated shift element N as the winding path gear (e.g. C2 (lsb.) power shifted to G1).

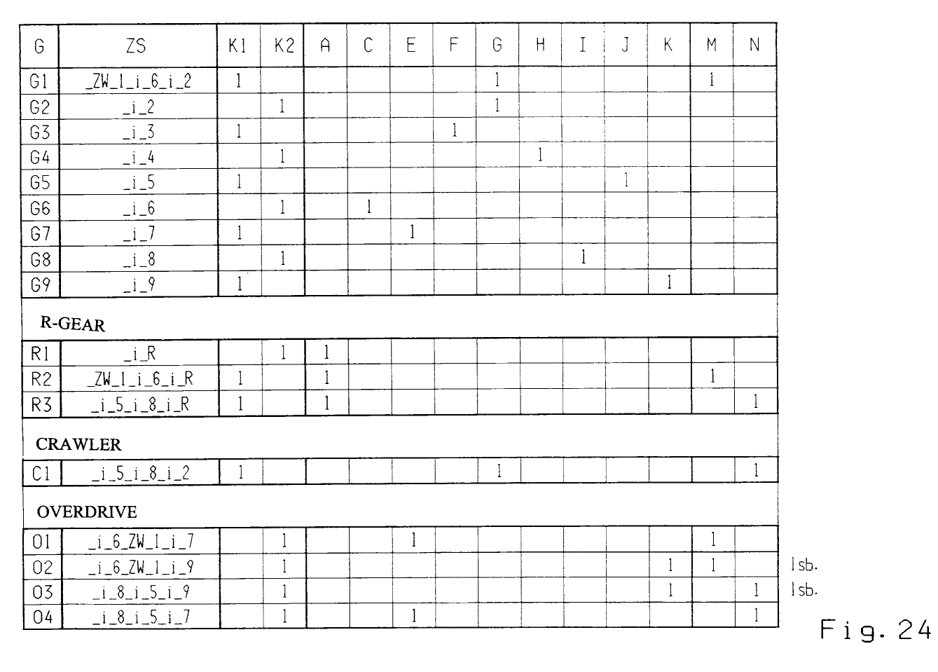

The table illustrated in FIG. 24 shows a shift pattern for the twelfth variant embodiment of the nine-gear double clutch transmission according to FIG. 23 by way of example.

The shift pattern shows that the first forward gear G1 may be shifted via the first clutch K1 and via the actuated coupling device G and via the actuated shift element M as the winding path gear, that the second forward gear G2 may be shifted via the second clutch K2 and via the actuated coupling device G, that the third forward gear G3 may be shifted via the first clutch K1 and via the actuated coupling device F, that the fourth forward gear G4 may be shifted via the second clutch K2 and via the actuated coupling device H, that the fifth forward gear G5 may be shifted via the first clutch K1 and via the actuated coupling device J, that the sixth forward gear G6 may be shifted via the second clutch K2 and via the actuated coupling device C, that the seventh forward gear G7 may be shifted via the first clutch K1 and via the actuated coupling device E, that the eighth forward gear G8 may be shifted via the second clutch K2 and via the actuated coupling device I, and that the ninth forward gear G9 may be carried out via the first clutch K1 and via the actuated coupling device K.

In the twelfth variant embodiment the table illustrated in FIG. 24 shows that a reverse gear R1 may be shifted via the second clutch K2 and via the actuated coupling device A, and/or that a further reverse gear R2 may be shifted via the first clutch K1 and via the actuated coupling device A and via the actuated shift element M as the winding path gear (e.g. R2 (lsb.) power shifted to R1), and/or that a subsequent reverse gear R3 may be shifted via the first clutch K1 and via the actuated coupling device A and via the actuated shift element N as the winding path gear (R3 (lsb.) power shifted to R1).

Furthermore, a crawler gear C1 may be shifted via the first clutch K1 and via the actuated coupling device G and via the actuated shift element N as the winding path gear. Also, an overdrive gear O1 may be shifted via the second clutch K2 and via the actuated coupling device E as well as via the actuated shift element M as the winding path gear. Furthermore, an additional overdrive gear O2 may be shifted via the second clutch K2 and via the actuated coupling device K as well as via the actuated shift element M as the winding path gear. A subsequent overdrive gear O3 may be shifted via the second clutch K2 and via the actuated coupling device K as well as via the actuated shift element N as the winding gear path. Finally, a further overdrive gear O4 may be shifted via the second clutch K2 and via the actuated coupling device E as well as via the actuated shift element N as the winding path gear. The overdrive gears O2 and O3 may be configured in a power shifting manner to the ninth forward gear G9 (e.g. O2 and O3 (lsb.) power shifted to G9).

The shift pattern according to FIG. 2 shows in detail that in the first forward gear G1 based on the first clutch K1 the gear stages i_3, i_4, and i_2 are utilized, wherein the two subtransmissions are coupled via the shift element M in the first variant embodiment. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Also, the gear stage i_R is utilized in the reverse gear R1. Furthermore, based on the second clutch K2 the gear stages i_4, i_3, and i_R are utilized in the further reverse gear R2, wherein the shift element M is actuated for coupling the two subtransmissions. Additionally, based on the first clutch K1 the gear stages i_R, i_2, and i_4 are utilized in the reverse gear R3, wherein the shift element N is actuated for coupling the two subtransmissions. Based on the second clutch K2 the gear stages i_4, i_3, and i_9 are utilized with the overdrive gear O1, wherein the two subtransmissions are coupled via the shift element M.

The shift pattern according to FIG. 4 shows in detail that in the first forward gear G1 based on the first clutch K1 the gear stages i_3, i_4, and i_2 are utilized, wherein the two subtransmissions are coupled via the shift element M in the first variant embodiment. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Further, based on the first clutch K1 the gear stage i_R is utilized in the reverse gear R1. Furthermore, based on the second clutch K2 the gear stages i_4, i_3, and i_R are utilized in the further reverse gear R2, wherein the two subtransmissions are coupled via the shift element M. Based on the second clutch K2 the gear stages i_4, i_3, and i_9 are utilized in the overdrive gear O1, wherein the two subtransmissions are coupled via the shift element M.

The shift pattern according to FIG. 6 shows in detail that based on the first clutch K1 the gear stages i_3, i_4, and i_2 are utilized in the first forward gear G1, wherein the two subtransmissions are coupled via the shift element M. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9 based on the first clutch K1. Also, based on the first clutch K1 the gear stage i_R is utilized with the reverse gear R2. Based on the second clutch K2 the gear stages i_4, i_3, and i_R are utilized in the further reverse gear R2, wherein the two subtransmissions are coupled via the shift element M. Furthermore, based on the second clutch K2 the gear stages i_4, i_3, and i_7 are utilized in the overdrive gear O1, wherein the two subtransmissions are coupled via the shift element M. based on the second clutch K2 the gear stages i_4, i_3, and i_9 are utilized in the subsequent overdrive gear O3, wherein the two subtransmissions are also coupled via the shift element M.

The shift pattern according to FIG. 8 shows in detail that in the first forward gear G1 the gear stages i_3, i_4, and i_2 are utilized, wherein the two subtransmissions are coupled via the shift element M. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Also, in the reverse gear R1 the gear stage i_R is utilized. In the further reverse gear R2, based on the first clutch K1, the gear stages i_3, i_4, and i_R are utilized, wherein the two subtransmissions are coupled via the shift element N. Based on the second clutch K2 the gear stages i_4, i_3, and i_9 are utilized in the overdrive gear O1, wherein the two subtransmissions are coupled to each other via the shift element M. Finally, based on the second clutch K2 the gear stages i_4, i_3, and i_7 are utilized in the overdrive gear O2, wherein the two subtransmissions are coupled to each other via the shift element M.

The shift pattern according to FIG. 10 shows in detail that in the first forward gear G1 the gear stages i_3, i_4, and i_2 are utilized, wherein the two subtransmissions are coupled via the shift element M. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Also, based on the first clutch K1 the gear stage i_R is utilized in the reverse gear R1. Based on the second clutch K2 the gear stages i_4, i_3, and i_R are utilized in the further reverse gear R2, wherein the two subtransmissions are coupled via the shift element M. Based on the first clutch K1 the gear stages i_R, i_6, and i_2 are utilized in the subsequent reverse gear R3, wherein the two subtransmissions are coupled to each other via the shift element N. Furthermore, based on the first clutch K1 the gear stages i_R, i_6, and i_8 are utilized in the further reverse gear R4, wherein the two subtransmissions are coupled via the shift element N. Finally, based on the first clutch K1 the gear steps i_R, i_6, and i_4 are utilized in the subsequent reverse gear R5, wherein the two subtransmissions are coupled to each other via the shift element N. Based on the second clutch K2 the gear steps i_4, i_3, and i_7 are utilized in the overdrive gear O1, wherein the two subtransmissions are coupled to each other via the shift element M. Also, based on the second clutch K2 the gear steps i_4, i_3, and i_9 are utilized in the subsequent overdrive gear, wherein the subtransmissions are coupled to each other via the shift element M.

The shift pattern according to FIG. 12 shows in detail that based on the first clutch K1 the gear stages i_3, i_4, and i_2 are utilized in the first forward gear G1, wherein the two subtransmissions are coupled via the shift element M. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Also, based on the second clutch K2 the gear stage i_R is utilized in the reverse gear R1. Based on the first clutch K1 the gear stages i_R, i_6, and i_2 are utilized in the further reverse gear R2, wherein the two subtransmissions are coupled via the shift element N. Based on the first clutch K1 the gear stages i_R, i_6, and i_8 are utilized in the subsequent reverse gear R3, wherein the two subtransmissions are coupled to each other via the shift element N. Furthermore, based on the first clutch K1 the gear stages i_R, i_6, and i_4 are utilized in the further reverse gear R4, wherein the two subtransmissions are coupled via the shift element N. Based on the second clutch K2 the gear steps i_4, i_3, and i_9 are utilized in the overdrive gear O1, wherein the two subtransmissions are coupled to each other via the shift element M. Also, based on the second clutch K2 the gear steps i_4, i_3, and i_7 are utilized in the subsequent overdrive gear, wherein the subtransmissions are coupled to each other via the shift element M.

The shift pattern according to FIG. 14 shows in detail that based on the first clutch K1 the gear stages i_5, i_6, and i_2 are utilized in the first forward gear G1, wherein the two subtransmissions are coupled via the shift element M. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Also, based on the first clutch K1 the gear stage i_R is utilized in the reverse gear R1. Based on the second clutch K2 the gear stages i_6, i_5, and i_R are utilized in the further reverse gear R2, wherein the two subtransmissions are coupled via the shift element M. Based on the first clutch K1 the gear stages i_R, i_2, and i_4 are utilized in the subsequent reverse gear R3, wherein the two subtransmissions are coupled to via the shift element N. Furthermore, based on the second clutch K2 the gear stages i_6, i_5, and i_9 are utilized in the overdrive gear O1, wherein the two subtransmissions are coupled via the shift element M. Based on the second clutch K2 the gear steps i_6, i_5, and i_7 are utilized in the overdrive gear O2, wherein the two subtransmissions are coupled to each other via the shift element M.

The shift pattern according to FIG. 16 shows in detail that in the first forward gear G1 the gear stage i_1 is utilized. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_7, i_6, and i_8 in the ninth forward gear G9 based on the first clutch K1, wherein the two subtransmissions are coupled via the shift element M. Also, the gear stage i_R is utilized in the reverse gear R1. Based on the second clutch K2 the gear stages i_6, i_7, and i_R are utilized in the reverse gear R2, wherein the two subtransmissions are coupled via the shift element M. Based on the first clutch K1 the gear stages 1_R, i_4, and i_2 are utilized in the reverse gear R3, wherein the two subtransmissions are coupled to each other via the shift element N. Finally, based on the second clutch K2 the gear stages i_6, i_7, and i_1 are utilized in the crawler gear C1, wherein the two subtransmissions are coupled to each other via the shift element M.

The shift pattern according to FIG. 18 shows in detail that in the first forward gear G1 the gear stage i_1 is utilized. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stages i_7, i_6, and i_8 in the ninth forward gear G9 based on the first clutch K1, wherein the two subtransmissions are coupled via the shift element M. Also, the gear stage i_R is utilized in the reverse gear R1. Based on the second clutch K2 the gear stages i_6, i_7, and i_1 are utilized in the crawler gear C1, wherein the two subtransmissions are coupled to each other via the shift element M. Based on the second clutch K2 the gear stages i_2, i_3, and i_1 are utilized in the crawler gear C2, wherein the two subtransmissions are coupled to each other via the shift element N. Finally, based on the first clutch K1 the gear stages i_3, i_2, and i_8 are utilized in the overdrive gear O1, wherein the two subtransmissions are coupled to each other via the shift element N.

The shift pattern according to FIG. 20 shows in detail that in the first forward gear G1 the gear stage i_1 is utilized. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage zw_9, i_2, and i_8 in the ninth forward gear G9 based on the first clutch K1, wherein the two subtransmissions are coupled via the shift element M. Also, the gear stage i_R is utilized in the reverse gear R1. Based on the first clutch K1 the gear stages zw_9, i_2, and i_R are utilized in the reverse gear R2, wherein the two subtransmissions are coupled to each other via the shift element M. Based on the first clutch K1 the gear stages i_7, i_6, and i_R are utilized in the reverse gear R3, wherein the two subtransmissions are coupled to each other via the shift element N. Based on the second clutch K2 the gear stages i_2, zw_9, and i_1 are utilized in the crawler gear C1, wherein the two subtransmissions are coupled to each other via the shift element M, and based on the second clutch K2 the gear stages i_6, i_7, and i_1 are utilized in the crawler gear C2, wherein the two subtransmissions are coupled to each other via the shift element N. Finally, based on the first clutch K1 the gear stages i_7, i_6, and i_8 are utilized in the overdrive gear O1, wherein the two subtransmissions are coupled to each other via the shift element N.

The shift pattern according to FIG. 22 shows in detail that in the first forward gear G1 the gear stage i_1 is utilized. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stages zw_9, i_4, and i_8 in the ninth forward gear G9 based on the first clutch K1, wherein the two subtransmissions are coupled via the shift element M. Also, the gear stage i_R is utilized in the reverse gear R1. Based on the first clutch K1 the gear stages zw_9, i_4, and i_R are utilized in the reverse gear R2, wherein the two subtransmissions are coupled via the shift element M. Based on the first clutch K1 the gear stages i_7, i_6, and i_R are utilized in the reverse gear R3, wherein the two subtransmissions are coupled to each other via the shift element N. Based on the second clutch K2 the gear stages i_4, zw_9, and i_1 are utilized in the crawler gear C1, wherein the two subtransmissions are coupled to each other via the shift element M, and based on the second clutch K2 the gear stages i_6, i_7, and i_1 are utilized in the crawler gear C2, wherein the two subtransmissions are coupled to each other via the shift element N.

The shift pattern according to FIG. 24 shows in detail that based on the first clutch K1 the gear stages zw_1, i_6, and i_2 are utilized in the first forward gear G1, wherein the two subtransmissions are coupled via the actuated shift element M. Furthermore, the gear stage i_2 is utilized in the second forward gear G2, the gear stage i_3 in the third forward gear G3, the gear stage i_4 in the fourth forward gear G4, the gear stage i_5 in the fifth forward gear G5, the gear stage i_6 in the sixth forward gear G6, the gear stage i_7 in the seventh forward gear G7, the gear stage i_8 in the eighth forward gear G8, and the gear stage i_9 in the ninth forward gear G9. Also, the gear stage i_R is utilized in the reverse gear R1. Based on the first clutch K1 the gear stages zw_1, i_6, and i_R are utilized in the reverse gear R2, wherein the two subtransmissions are coupled via the shift element M. Based on the first clutch K1 the gear stages i_5, i_8, and i_R are utilized in the reverse gear R3, wherein the two subtransmissions are coupled to each other via the shift element N. Based on the first clutch K1 the gear stages i_5, i_8, and i_2 are utilized in the crawler gear C1, wherein the two subtransmissions are coupled to each other via the shift element N. Based on the second clutch K2 the gear stages i_6, zw_1, and i_7 are utilized in the overdrive gear O1, wherein the two subtransmissions are coupled to each other via the shift element M. Based on the second clutch K2 the gear stages i_6, zw_1, and i_9 are utilized in the overdrive gear O2, wherein the two subtransmissions are coupled to each other via the shift element M. Based on the second clutch K2 the gear stages i_8, i_5, and i_9 are utilized in the subsequent overdrive gear O3, wherein the two subtransmissions are coupled via the shift element N. Based on the second clutch K2 the gear stages i_8, i_5, and i_7 are utilized in the further overdrive gear O4, wherein the two subtransmissions are coupled via the shift element N.

In the first, second, third, fourth, fifth, and sixth variant embodiments according to FIGS. 1 to 12 the winding path gear may be realized in the first forward gear G1 via the gear stages i_3, i_4, and i_2.

In summary a free selection of transmission ratios is achieved in the first variant embodiment according to FIGS. 1 and 2 in the gears G6, G7, and G8 on the single gear planes. In this manner a good stage adjustment of the upper gears is obtained. Using an additional overdrive gear O1 that may be power shifted to the ninth forward gear G9 results in a possible tenth forward gear. Fuel may be saved in this manner.

The first variant embodiment shows in detail that the idler gear 13 is utilized for one forward gear G6 at the first gear plane 1-13 as the single gear plane. The idler gear 14 is also utilized for one forward gear G8 at the second gear plane 2-14. The idler gear 9 is utilized for three forward gears G1, G4, and O1 and for two reverse gears R2, R3 at the third gear plane 9-15 as the dual gear plane, and the idler gear 15 is utilized for two forward gears G1, G2 and for one reverse gear R3. The idler gear 10 is utilized for three forward gears G1, G3, and O1 and for one reverse gear R2, and the idler gear 16 is utilized for three reverse gears R1, R2, R3 at the fourth gear plane 10-16 as the dual gear plane. The idler gear 11 is utilized for two forward gears G9, O1, and the idler gear 17 is utilized for one forward gear G5 at the fifth gear plane 11-17 as the dual gear plane. Finally, the idler gear 12 is utilized for one forward gear G7 at the sixth gear plane 12-6 as the single gear plane.

In summary the same advantages are achieved in the second variant embodiment according to FIGS. 3 and 4 as in the first variant embodiment, however, due to the arrangement of the seventh forward gear G7 on the first countershaft w_v1 a more improved stage adjusted is obtained.

The second variant embodiment shows in detail that the idler gear 13 is utilized for one forward gear G6 at the first gear plane 1-13 as the single gear plane. The idler gear 14 is utilized for one forward gear G8 at the second gear plane 2-14. The idler gear 9 is utilized for three forward gears G1, G4, and O1 and for one reverse gear R2 at the third gear plane 9-15 as the dual gear plane, and the idler gear 15 is utilized for two forward gears G1, G2. The idler gear 10 is utilized for three forward gears G1, G3, and O1 and for one reverse gear R2, and the idler gear 16 is utilized for two reverse gears R1, R2 at the fourth gear plane 10-16 as the dual gear plane. The idler gear 11 is utilized for two forward gears G9, O1, and the idler gear 17 is utilized for one forward gear G5 at the fifth gear plane 11-17 as the dual gear plane. Finally, the idler gear 18 is utilized for one forward gear G7 at the sixth gear plane 6-18 as the single gear plane.

In summary a free selection of transmission ratios of the gears G6, G7, and G8 is obtained on the single gear planes in the third variant embodiment according to FIGS. 5 and 6. Fuel savings can be realized using an additional overdrive gear O2 that may be power shifted to the forward gear G9, and a non-power shifting overdrive gear O1.

The third variant embodiment shows in detail that the idler gear 13 is utilized for one forward gear G6 at the first gear plane 1-13 as the single gear plane. The idler gear 14 is utilized for one forward gear G8 at the second gear plane 2-14 as the single gear plane. The idler gear 9 is utilized for four forward gears G1, G4, O1, O4, and for one reverse gear R2, and the idler gear 15 is utilized for two forward gears G1, G2 at the third gear plane 9-15 as the dual gear plane. The idler gear 10 is utilized for four forward gears G1, G3, O1, and O2 and for one reverse gear R2, and the idler gear 16 is utilized for two reverse gears R1, R2 at the fourth gear plane 10-16 as the dual gear plane. The idler gear 11 is utilized for two forward gears G7, O1, and the idler gear 17 is utilized for one forward gear G5 at the fifth gear plane 11-17 as the dual gear plane. Finally, the idler gear 18 is utilized for two forward gears G9, O2 at the sixth gear plane 6-18 as the single gear plane.

In summary an approximately balanced clutch load is obtained in the fourth variant embodiment according to FIGS. 7 and 8, as the first forward gear G1 and the third forward gear G3 are shifted via the first clutch K1, and the second forward gear G2 and the reverse gear R1 are shifted via the second clutch K2. Furthermore, a similar clutch dimensioning is also achieved.

The fourth variant embodiment shows in detail that the idler gear 7 is utilized for two reverse gears R1, R2 and the idler gear 13 is utilized for two forward gears G1, G2 at the first gear plane 7-13 as the dual gear plane. The idler gear 14 is utilized for one forward gear G6 at the second gear plane 2-14 as the single gear plane. The idler gear 9 is utilized for four forward gears G1, G4, O1, O2, and for one reverse gear R2, and the idler gear 15 is utilized for one forward gear G8 at the third gear plane 9-15 as the dual gear plane. The idler gear 10 is utilized for four forward gears G1, G3, O1, and O2 and for one reverse gear R2 at the fourth gear plane 10-4 as the single gear plane. The idler gear 11 is utilized for one forward gear G5, and the idler gear 17 is utilized for two forward gears G9, O1 at the fifth gear plane 11-17 as the dual gear plane. Finally, the idler gear 18 is utilized for two forward gears G7, O2 at the sixth gear plane 6-18 as the single gear plane.

In summary a free selection of transmission ratios of the gears G2, G8, and G9 is obtained at the single gear planes in the fifth variant embodiment according to FIGS. 9 and 10. An additional overdrive gear O2 that can be power shifted to the ninth forward gear G9, may realize fuel savings. Furthermore, the first countershaft w_v1 is power-shifted with the gears G3, G4, and G5 as well as with the first forward gear G1 as the winding path gear. Due to the adjacent arrangement of the three idler gears a good shaft and bearing dimensioning is possible despite of high loads.

The fifth variant embodiment shows in detail that the idler gear 13 is utilized for two forward gears G1, G2 and for one reverse gear R3 at the first gear plane 1-13 as the single gear plane. The idler gear 14 is utilized for one forward gear G8 and one reverse gear R4 at the second gear plane 2-14 as the single gear plane. The idler gear 9 is utilized for four forward gears G1, G4, O1, O2, and for two reverse gears R2, R5, and the idler gear 15 is utilized for one forward gear G6 and for three reverse gears R3, R4, R5 at the third gear plane 9-15 as the dual gear plane. The idler gear 10 is utilized for four forward gears G1, G3, O1, and O2 and for one reverse gear R2, and the idler gear 16 is utilized for five reverse gears R1, R2, R3, R4, R5 at the fourth gear plane 10-16 as the dual gear plane. The idler gear 11 is utilized for one forward gear G5, and the idler gear 17 is utilized for two forward gears G7, O1 at the fifth gear plane 11-17 as the dual gear plane. Finally, the idler gear 18 is utilized for two forward gears G9, O2 at the sixth gear plane 6-18 as the single gear plane.

In summary similar advantage are obtained in the sixth variant embodiment according to FIGS. 11 and 12 as in the fifth variant embodiment. Furthermore, a free selection of transmission ratios of the gears G2, G7, and G8 is obtained at the single gear planes. An additional overdrive gear O1 that can be power shifted to the ninth forward gear G9, may realize fuel savings. Furthermore, improved stage adjustments are possible in that the seventh forward gear G7, and not the ninth forward gear G9, is positioned on a single gear plane.

The sixth variant embodiment shows in detail that the idler gear 13 is utilized for two forward gears G1, G2 and for one reverse gear R2 at the first gear plane 1-13 as the single gear plane. The idler gear 14 is utilized for one forward gear G8 and one reverse gear R3 at the second gear plane 2-14 as the single gear plane. The idler gear 9 is utilized for four forward gears G1, G4, O1, O2, and for one reverse gear R4, and the idler gear 15 is utilized for one forward gear G6 and for three reverse gears R2, R3, R4 at the third gear plane 9-15 as the dual gear plane. The idler gear 10 is utilized for four forward gears G1, G3, O1, and O2, and the idler gear 16 is utilized for four reverse gears R1, R2, R3, R4, at the fourth gear plane 10-16 as the dual gear plane. The idler gear 11 is utilized for one forward gear G5, and the idler gear 17 is utilized for two forward gears G9, O1 at the fifth gear plane 11-17 as the dual gear plane. Finally, the idler gear 18 is utilized for two forward gears G7, O2 at the sixth gear plane 6-18 as the single gear plane.

In summary one winding path gear is obtained in the first forward gear via the transmission ratios of the fifth, sixth, and the second gear in the seventh variant embodiment according to FIGS. 13 and 14. Furthermore, a free selection of transmission ratios of the gears G4, G7, and G8 is obtained at the singe gear planes. An additional overdrive gear O1 that can be power shifted to the ninth forward gear G9, may realize fuel savings. Also, a different stage characteristic is obtained by means of the first forward gear G1 as the winding path gear from the transmission ratios of the fifth, sixth, and second gears.

The seventh variant embodiment shows in detail that the idler gear 13 is utilized for one forward gear G4 and one reverse gear R3 at the first gear plane 1-13 as the single gear plane. The idler gear 14 is utilized for one forward gear G8 at the second gear plane 2-14 as the single gear plane. The idler gear 9 is utilized for four forward gears G1, G6, O1, O2 and for one reverse gear R2, and the idler gear 15 is utilized for two forward gears G1, G2 and for one reverse gear R3 at the third gear plane 9-15 as the dual gear plane. The idler gear 10 is utilized for four forward gears G1, G5, O1, and O2 and for one reverse gear R2, and the idler gear 16 is utilized for three reverse gears R1, R2, R3, at the fourth gear plane 10-16 as the dual gear plane. The idler gear 11 is utilized for two forward gears G9, O1, and the idler gear 17 is utilized for one forward gear G3 at the fifth gear plane 11-17 as the dual gear plane. Finally, the idler gear 12 is utilized for two forward gears G7, O2 at the sixth gear plane 12-6 as the single gear plane.

In the eighth variant embodiment according to FIGS. 15 and 16 the winding path gear is realized in the ninth forward gear via the transmission ratios of the gears G7, G6, and G8. A free selection of transmission ratios of the gears G1, G2, and G8 is obtained at the singe gear planes. Furthermore, a good adjustability of the stages in the lower gears is achieved. Using a crawler gear C1 that can be power shifted to the first forward gear G1, improved terrain driving characteristic may be achieved.

The eighth variant embodiment shows in detail that the idler gear 13 is utilized for two forward gears G8, G9 at the first gear plane 1-13 as the single gear plane. The idler gear 14 is utilized for one forward gear G2 and one reverse gear R3 at the second gear plane 2-14 as the single gear plane. The idler gear 9 is utilized for three forward gears G6, G9, C1 and for one reverse gear R2, and the idler gear 15 is utilized for one forward gear G4 and for one reverse gear R3 at the third gear plane 9-15 as the dual gear plane. The idler gear 10 is utilized for three forward gears G7, G9, C1 and for one reverse gear R2, and the idler gear 16 is utilized for three reverse gears R1, R2, R3 at the fourth gear plane 10-16 as the dual gear plane. The idler gear 11 is utilized for one forward gear G5, and the idler gear 17 is utilized for one forward gear G3 at the fifth gear plane 11-17 as the dual gear plane. Finally, the idler gear 18 is utilized for two forward gears G1, C1 at the sixth gear plane 6-18 as the single gear plane.

In the ninth variant embodiment according to FIGS. 17 and 18 a free selection of transmission ratios of the gears G4, G8, and R is obtained at the singe gear planes. An alternate ninth forward gear may be realized using an additional overdrive gear O1 that can be power shifted to the eighth forward gear G8, leading to fuel savings. In the ninth variant embodiment the ninth forward gear G9 may also be realized as a winding path gear via the transmission ratios of the gears G7, G6, and G8.

The ninth variant embodiment shows in detail that the idler gear 13 is utilized for three forward gears G8, G9, O1 at the first gear plane 1-13 as the single gear plane. The idler gear 14 is utilized for one forward gear G4 at the second gear plane 2-14 as the single gear plane. The idler gear 9 is utilized for three forward gears G6, G9, C1, and the idler gear 15 is utilized for three forward gears G2, C2, O1 at the third gear plane 9-15 as the dual gear plane. The idler gear 10 is utilized for three forward gears G7, G9, C1, and the idler gear 16 is utilized for three forward gears G3, C2, O1 at the fourth gear plane 10-16 as the dual gear plane. The idler gear 11 is utilized for one forward gear G5, and the idler gear 17 is utilized for three forward gears G1, C1, C2 at the fifth gear plane 11-17 as the dual gear plane. Finally, the idler gear 12 is utilized for one reverse gear R1 at the sixth gear plane 12-6 as the single gear plane.

In the tenth and eleventh variant embodiments according to FIGS. 19 to 22 the winding path gear is obtained in the ninth forward gear G9 with an additional gear stage zw_9 that is not utilized in any other forward gear. Using a reverse gear R1 that can be power shifted to the first forward gear G1, and a further reverse gear R2 that can be power shifted to the reverse gear R1, a loosening by means of rocking can be enabled. Improved terrain driving characteristics can be realized using a crawler gear C1 that can be power shifted to the first forward gear G1. Furthermore, in the tenth variant embodiment an additional overdrive gear O1 that can be power shifted to the eighth forward gear G8 is obtained, leading to fuel savings.

The tenth variant embodiment shows in detail that the idler gear 13 is utilized for three forward gears G8, G9, O1 at the first gear plane 1-13 as the single gear plane. The idler gear 8 is utilized for three reverse gears R1, R2, R3, and the idler gear 14 is utilized for one forward gear G4 at the second gear plane 8-14 as the dual gear plane. The idler gear 9 is utilized for three forward gears G2, G9, C1 and for one reverse gear R2, and the idler gear 15 is utilized for three forward gears G6, C2, 01 and for one reverse gear R3 at the third gear plane 9-15 as the dual gear plane. The idler gear 10 is utilized for two forward gears G9, C1 and for one reverse gear R2, and the idler gear 16 is utilized for three forward gears G7, O1, C2 and for one reverse gear R3 at the fourth gear plane 10-16 as the dual gear plane. The idler gear 11 is utilized for three forward gears G1, C1, C2 and the idler gear 17 is utilized for one forward gear G5, at the fifth gear plane 11-17 as the dual gear plane. Finally, the idler gear 12 is utilized for one forward gear G3 at the sixth gear plane 12-6 as the single gear plane.

In the eleventh variant embodiment according to FIGS. 21 and 22 the adjustability of the stages may be further improved by means of a changed gear arrangement in the first and third forward gears.

The eleventh variant embodiment shows in detail that the idler gear 13 is utilized for two forward gears G8, G9 at the first gear plane 1-13 as the single gear plane. The idler gear 8 is utilized for three reverse gears R1, R2, R3, and the idler gear 14 is utilized for one forward gear G2 at the second gear plane 8-14 as the dual gear plane. The idler gear 9 is utilized for three forward gears G4, G9, C1 and for one reverse gear R2, and the idler gear 15 is utilized for two forward gears G6, C2 and for one reverse gear R3 at the third gear plane 9-15 as the dual gear plane. The idler gear 10 is utilized for two forward gears G9, C1 and for one reverse gear R2, and the idler gear 16 is utilized for two forward gears G7, C2 and for one reverse gear R3 at the fourth gear plane 10-16 as the dual gear plane. The idler gear 11 is utilized for one forward gear G3, and the idler gear 17 is utilized for one forward gear G5, at the fifth gear plane 11-17 as the dual gear plane. Finally, the idler gear 12 is utilized for three forward gears G1, C1, C2 at the sixth gear plane 12-6 as the single gear plane.

In the twelfth variant embodiment according to FIGS. 23 and 24 the winding path gear is realized in the first forward gear G1 via the additional gear stage zw_1, which is not used in any other forward gear. Furthermore, the transmission ratios of the sixth and the second gear are utilized. Also, a good adjustability of the stages is obtained, since the gears G3 and G4 are arranged at the single gear planes. Fuel savings may be realized using an overdrive gear O2 that can be power shifted to the ninth forward gear G9.

The twelfth variant embodiment shows in detail that the idler gear 7 is utilized for three reverse gears R1, R2, R3, and the idler gear 13 is utilized for three forward gears G1, G2, C1 at the first gear plane 7-13 as the dual gear plane. The idler gear 14 is utilized for one forward gear G4 at the second gear plane 2-14 as the single gear plane. The idler gear 9 is utilized for four forward gears G1, G6, O1, O2 and for one reverse gear R2, and the idler gear 15 is utilized for four forward gears G8, C1, O1, O2 and for one reverse gear R3 at the third gear plane 9-15 as the dual gear plane. The idler gear 10 is utilized for three forward gears G1, O1, O2 and for one reverse gear R2, and the idler gear 16 is utilized for four forward gears G5, C1, O3, O4 and for one reverse gear R3 at the fourth gear plane 10-16 as the dual gear plane. The idler gear 11 is utilized for three forward gears G7, O1, O4, and the idler gear 17 is utilized for three forward gears G9, O2, O3 at the fifth gear plane 11-17 as the dual gear plane. Finally, the idler gear 12 is utilized for one forward gear G3 at the sixth gear plane 12-6 as the single gear plane.

In all variant embodiments of the double clutch transmission fewer gear planes, and thus fewer components are necessary at a consistent number of gears due to said multiple uses of individual idler gears provided such that an advantageous construction space and cost savings is brought about.

Regardless of the respective variant embodiment the numeral “1” in a field of the respective table of the shift pattern according to FIGS. 2, 4, 6, 8, 10, 12, 14, 16, 18, 20, 22, and 24 means that the associated clutch K1, K2, or the associated coupling device A, B, C, D, E, F, G, H, I, J, K, L, or the associated shift element M, N is closed. In contrast, a free field in the respective table of the shift pattern according to FIGS. 2, 4, 6, and 8 means that the associated clutch K1, K2, or the associated coupling device A, B, C, D, E, F, G, H, I, J, K, L, or the associated shift element M, N is open. Furthermore, it is possible in many cases to incorporate further coupling or shift elements without having an adverse effect on the flow of power. In this manner a pre-selection of gears may be enabled.

### REFERENCE SYMBOLS

1 fixed gear of the second transmission input shaft
2 fixed gear of the second transmission input shaft
3 fixed gear of the second transmission input shaft
4 fixed gear of the first transmission input shaft
5 fixed gear of the first transmission input shaft
6 fixed gear of the first transmission input shaft
7 idler gear of the first countershaft
8 idler gear of the first countershaft
9 idler gear of the first countershaft
10 idler gear of the first countershaft
11 idler gear of the first countershaft
12 idler gear of the first countershaft
13 idler gear of the second countershaft
14 idler gear of the second countershaft
15 idler gear of the second countershaft
16 idler gear of the second countershaft
17 idler gear of the second countershaft
18 idler gear of the second countershaft
19 fixed gear of the output shaft
20 output gear of the first countershaft
21 output gear of the first countershaft
22 torsion vibration damper
K1 first clutch
K2 second clutch
w_an drive shaft
w_ab output shaft
w_v1 first countershaft
w_v2 second counter shaft
w_k1 first transmission input shaft
w_k2 second transmission input shaft
A coupling device
B coupling device
C coupling device
D coupling device
E coupling device
F coupling device
G coupling device
H coupling device
I coupling device
J coupling device
K coupling device
L coupling device
i_1 gear stage first forward gear
i_2 gear stage second forward gear
i_3 gear stage third forward gear
i_4 gear stage fourth forward gear
i_5 gear stage fifth forward gear
i_6 gear stage sixth forward gear
i_7 gear stage seventh forward gear
i_8 gear stage eighth forward gear
i_9 gear stage ninth forward gear
zw_1 intermediate stage gear
zw_9 intermediate stage gear
G1 first forward gear
G2 second forward gear
G3 third forward gear
G4 fourth forward gear
G5 fifth forward gear
G6 sixth forward gear
G7 seventh forward gear
G8 eighth forward gear
G9 ninth forward gear
C1 crawler gear (crawler)
C2 crawler gear
O1 overdrive gear (overdrive)
O2 overdrive gear
O3 overdrive gear
O4 overdrive gear
R1 reverse gear
R2 reverse gear
R3 reverse gear
R4 reverse gear
R5 reverse gear
w_zw intermediate shaft
ZR intermediate gear
ZS gear stage utilized
M shift element
N shift element
lsb. power shifted

1-23. (canceled)

24. A double clutch transmission comprising
first and second clutches (K1, K2) each comprising an input side connected to a drive shaft (w_an) and an output side connected to a respective one of first and second transmission input shafts (w_k1, w_k2) arranged coaxially relative to one another;
at least first and second countershafts (w_v1, w_v2) having toothed idler gearwheels (7, 8, 9, 10, 11, 12, 13, 14, 15, 16, 17, 18) supported thereon;
toothed fixed gearwheels (1, 2, 3, 4, 5, 6) being supported on the first and the second transmission input shafts (w_k1, w_k2) in a rotationally fixed manner; and each of the fixed gearwheels (1, 2, 3, 4, 5, 6) meshing with at least one of the idler gearwheels (7, 8, 9, 10, 11, 12, 13, 14, 15, 16, 17, 18);
a plurality of coupling devices (A, B, C, D, E, F, G, H, I, J, K, L) for respectively coupling an idler gearwheel (7, 8, 9, 10, 11, 12, 13, 14, 15, 16, 17, 18) to one of the first and the second countershafts (w_v1, w_v2) in a rotationally fixed manner;
one output gear (20, 21) being provided on each of the first and the second countershafts (w_v1, w_v2), and each of the output gears being coupled to a common gearing of an output shaft (w_ab);
at least one shift element (M) for coupling two of the toothed idler gearwheels (7, 8, 9, 10, 11, 12, 13, 14, 15, 16, 17, 18) in a rotationally fixed manner, such that a plurality of power shifting forward gears (1, 2, 3, 4, 5, 6, 7, 8, 9) and at least one reverse gear (R1, R2, R3, R4) can be shifted;
the double clutch transmission having six gear planes (1-13, 7-13, 8-14, 2-14, 9-15, 10-4, 10-16, 11-17, 12-6, 6-18) comprising at least three dual gear planes (7-13, 8-14, 9-15, 10-16, 11-17) and at least two single gear planes (1-13, 2-14, 10-4, 12-6, 6-18), each of the at least three dual gear planes comprising one idler gearwheel (7, 8, 9, 10, 11, 13, 14, 15, 16, 17) of each of the first and the second countershafts (w_v1, w_v2) and a fixed gearwheel (1, 2, 3, 4, 5) of one of the first and the second transmission input shafts (w_k1, w_k2), and at least one of the two idler gears (7, 8, 9, 10, 11, 13, 14, 15, 16, 17) in each of the dual gear planes (7-13, 8-14, 9-15, 10-16, 11-17) being utilized for at least two gears, and each of the at least two single gear planes (1-13, 2-14, 10-4, 12-6, 6-18) comprising one idler gearwheel (10, 12, 13, 14, 18) of the first and the second countershafts (w_v1, w_v2) and a fixed gear (1, 2, 4, 6) of one of the first and the second transmission input shafts (w_K1, w_K2) such that at least one power shifting winding path gear is shiftable via the at least one shift element (M).

25. The double clutch transmission according to claim 24, wherein the six gear planes comprise first, second and third dual gear planes (7-13, 9-15, 10-16, 11-17) and first, second and third single gear planes (1-13, 2-14, 10-4, 12-6, 6-18).

26. The double clutch transmission according to claim 24, wherein the six gear planes comprise first, second, third and fourth dual gear planes (7-13, 8-14, 9-15, 10-16, 11-17) and first and second single gear planes (1-13, 2-14, 12-6).

27. The double clutch transmission according to claim 24, wherein an idler gearwheel (9) of a second sub-transmission is connectable to an idler gearwheel (10) of a first sub-transmission on the first countershaft (w_v1) via the at least one shift element (M) such that at least one of a first forward gear (G1), a reverse gear (R2), and at least one overdrive gear (O1, O2) is shiftable as a winding path gear via activation of the at least one shift element (M).

28. The double clutch transmission according to claim 24, wherein an idler gearwheel (9) of a second sub-transmission is connectable to an idler gearwheel (10) of a first sub-transmission on the first countershaft (w_v1) via the at least one shift element (M) such that at least one of a ninth forward gear (G9), a reverse gear (R2), and a crawler gear (C1) is shiftable as a winding path gear via activation of the at least one shift element (M).

29. The double clutch transmission according to claim 24, wherein a first gear plane (1-13) and a second gear plane (2-14) are single gear planes, and a third gear plane (9-15) is a dual gear plane, and the first, the second and the third gear planes comprise three fixed gearwheels (1, 2, 3) supported by the second transmission input shaft (w_k2) of a second sub-transmission.

30. The double clutch transmission according to claim 29, wherein a fourth gear plane (10-16) and a fifth gear plane (11-17) are dual gear planes, and a sixth gear plane (12-6, 6-18) is being a single gear plane, and the fourth, the fifth the and sixth gear planes comprise three fixed gears (4, 5, 6) supported on the first transmission input shaft (w_k1) of a first sub-transmission.

31. The double clutch transmission according to claim 24, wherein a first gear plane (1-13) is a single gear plane and a second gear plane (2-14) and a third gear plane (8-14, 9-15) are dual gear planes, and the first, the second and the third gear planes comprise three fixed gears (1, 2, 3) supported on the second transmission input shaft (w_k2) of a second sub-transmission.

32. The double clutch transmission according to claim 31, wherein a fourth gear plane (10-16) and a fifth gear plane (11-17) are dual gear planes, and a sixth gear plane (12-6) is a single gear plane, and the fourth, the fifth the and sixth gear planes comprise three fixed gears (4, 5, 6) supported on the first transmission input shaft (w_k1) of a first sub-transmission.

33. The double clutch transmission according to claim 24, wherein a first gear plane (7-13) is a dual gear plane and a second gear plane (2-14) is a single gear plane and a third gear plane (9-15) is a dual gear plane, and the first, the second and the third gear planes comprise three fixed gears (1, 2, 3) supported on the second transmission input shaft (w_k2) of a second sub-transmission.

34. The double clutch transmission according to claim 33, wherein a fourth gear plane (10-16, 10-4) is one of a dual gear plane and a single gear plane, and a fifth gear plane (11-17) is a dual gear plane and a sixth gear plane (12-6, 6-18) is a single gear plane, and the fourth, the fifth the and sixth gear planes comprise three fixed gears (4, 5, 6) supported on the first transmission input shaft (w_k1) of a first sub-transmission.

35. The double clutch transmission according to claim 24, wherein
a first forward gear (G1) is shiftable as a winding path gear via activation of the first clutch (K1), a ninth coupling device (I), and the at least one shift element (M);
a second forward gear (G2) is shiftable via activation of the second clutch (K2) and the ninth coupling device (I);
a third forward gear (G3) is shiftable via activation of the first clutch (K1) and a fourth coupling device (D);
a fourth forward gear (G4) is shiftable via activation of the second clutch (K2) and a third coupling device (C);
a fifth forward gear (G5) is shiftable via activation of the first clutch (K1) and an eleventh coupling device (K);
a sixth forward gear (G6) is shiftable via activation of the second clutch (K2) and a seventh coupling device (G);
a seventh forward gear (G7) is shiftable via activation of the first clutch (K1) and a sixth coupling device (F);
an eighth forward gear (G8) is shiftable via activation of the second clutch (K2) and an eighth coupling device (H);
a ninth forward gear (G9) is shiftable via activation of the first clutch (K1) and a fifth coupling device (E);
a first reverse gear (R1) is shiftable via activation of the first clutch (K1) and a tenth coupling device (J);
a second reverse gear (R2) is shiftable as a winding path gear via activation of the second clutch (K2), the tenth coupling device (J) and the at least one shift element (M);
a reverse gear (R3) is shiftable as a winding path gear via activation of the first clutch (K1), the third coupling device (C) and a second shift element (N); and
an overdrive gear (O1) is shiftable as a winding path gear via activation of the second clutch (K2), the fifth coupling device (E) and the at least one shift element (M).

36. The double clutch transmission according to claim 24, wherein
a first forward gear (G1) is shiftable as a winding path gear via activation of the first clutch (K1), a ninth coupling device (I), and the at least one shift element (M);
a second forward gear (G2) is shiftable via activation of the second clutch (K2) and the ninth coupling device (I);
a third forward gear (G3) is shiftable via activation of the first clutch (K1) and a fourth coupling device (D);
a fourth forward gear (G4) is shiftable via activation of the second clutch (K2) and a third coupling device (C);
a fifth forward gear (G5) is shiftable via activation of the first clutch (K1) and an eleventh coupling device (K);
a sixth forward gear (G6) is shiftable via activation of the second clutch (K2) and a seventh coupling device (G);
a seventh forward gear (G7) is shiftable via activation of the first clutch (K1) and a twelfth coupling device (L);
an eighth forward gear (G8) is shiftable via activation of the second clutch (K2) and an eighth coupling device (H);
a ninth forward gear (G9) is shiftable via activation of the first clutch (K1) and a fifth coupling device (E);
a first reverse gear (R1) is shiftable via activation of the first clutch (K1) and a tenth coupling device (J);
a reverse gear (R2) is shiftable as a winding path gear via activation of the second clutch (K2), the tenth coupling device (J) and the at least one shift element (M);
an overdrive gear (O1) is shiftable as a winding path gear via activation of the second clutch (K2), the fifth coupling device (E) and the at least one shift element (M).

37. The double clutch transmission according to claim 24, wherein
a first forward gear (G1) is shiftable as a winding path gear via activation of the first clutch (K1), a ninth coupling device (I), and the at least one shift element (M);
a second forward gear (G2) is shiftable via activation of the second clutch (K2) and the ninth coupling device (I);
a third forward gear (G3) is shiftable via activation of the first clutch (K1) and a fourth coupling device (D);
a fourth forward gear (G4) is shiftable via activation of the second clutch (K2) and a third coupling device (C);
a fifth forward gear (G5) is shiftable via activation of the first clutch (K1) and an eleventh coupling device (K);
a sixth forward gear (G6) is shiftable via activation of the second clutch (K2) and a seventh coupling device (G);
a seventh forward gear (G7) is shiftable via activation of the first clutch (K1) and a fifth coupling device (E);
an eighth forward gear (G8) is shiftable via activation of the second clutch (K2) and an eighth coupling device (H); and
a ninth forward gear (G9) is shiftable via activation of the first clutch (K1) and a twelfth coupling device (L);
a first reverse gear (R1) is shiftable via activation of the first clutch (K1) and a tenth coupling device (J);
a second reverse gear (R2) is shiftable as a winding path gear via activation of the second clutch (K2), the tenth coupling device (J) and the at least one shift element (M);
a first overdrive gear (O1) is shiftable via activation of the second clutch (K2) and the fifth coupling device (E); and
a second overdrive gear (O2) is shiftable as a winding path gear via activation of the second clutch (K2), the twelfth coupling device (L) and the at least one shift element (M).

38. The double clutch transmission according to claim 24, wherein
a first forward gear (G1) is shiftable as a winding path gear via activation of the first clutch (K1), a seventh coupling device (G) and the at least one shift element (M);
a second forward gear (G2) is shiftable via activation of the second clutch (K2) and the seventh coupling device (G);
a third forward gear (G3) is shiftable via activation of the first clutch (K1) and a fourth coupling device (D);
a fourth forward gear (G4) is shiftable via activation of the second clutch (K2) and a third coupling device (C);
a fifth forward gear (G5) is shiftable via activation of the first clutch (K1) and a fifth coupling device (E);
a sixth forward gear (G6) is shiftable via activation of the second clutch (K2) and an eighth coupling device (H);
a seventh forward gear (G7) is shiftable via activation of the first clutch (K1) and a twelfth coupling device (L);
an eighth forward gear (G8) is shiftable via activation of the second clutch (K2) and a ninth coupling device (I);
a ninth forward gear (G9) is shiftable via activation of the first clutch (K1) and an eleventh coupling device (K);
a first reverse gear (R1) is shiftable via activation of the second clutch (K2) and a first coupling device (A);
a second reverse gear (R2) is shiftable as a winding path gear via activation of the first clutch (K1), the first coupling device (A) and the at least one shift element (M);
a first overdrive gear (O1) is shiftable as a winding path gear via activation of the second clutch (K2), the eleventh coupling device (K) and the at least one shift element (M); and
a second overdrive gear (O2) is shiftable as a winding path gear via activation of the second clutch (K2), the twelfth coupling device (L) and the at least one shift element (M).

39. The double clutch transmission according to claim 24, wherein
a first forward gear (G1) is shiftable as a winding path gear via activation of the first clutch (K1), a seventh coupling device (G) and the at least one shift element (M);
a second forward gear (G2) is shiftable via activation of the second clutch (K2) and the seventh coupling device (G);
a third forward gear (G3) is shiftable via activation of the first clutch (K1) and a fourth coupling device (D);
a fourth forward gear (G4) is shiftable via activation of the second clutch (K2) and a third coupling device (C);
a fifth forward gear (G5) is shiftable via activation of the first clutch (K1) and a fifth coupling device (E);
a sixth forward gear (G6) is shiftable via activation of the second clutch (K2) and a ninth coupling device (I);
a seventh forward gear (G7) is shiftable via activation of the first clutch (K1) and an eleventh coupling device (K);
an eighth forward gear (G8) is shiftable via activation of the second clutch (K2) and an eighth coupling device (H);
a ninth forward gear (G9) is shiftable via activation of the first clutch (K1) and a twelfth coupling device (L);
a first reverse gear (R1) is shiftable via activation of the first clutch (K1) and a tenth coupling device (J);
a second reverse gear (R2) is shiftable as a winding path gear via activation of the second clutch (K2), the tenth coupling device (J) and the at least one shift element (M);
a third reverse gear (R3) is shiftable as a winding path gear via activation of the first clutch (K1), the seventh coupling device (G) and a second shift element (N);
a fourth reverse gear (R4) is shiftable as a winding path gear via activation of the first clutch (K1), the eighth coupling device (H) and the second shift element (N);
a fifth reverse gear (R5) is shiftable as a winding path gear via activation of the first clutch (K1), the third coupling device (C) and the second shift element (N);
a first overdrive gear (O1) is shiftable as a winding path gear via activation of the second clutch (K2), the eleventh coupling device (K) and the at least one shift element (M); and
a second overdrive gear (O2) is shiftable as a winding path gear via activation of the second clutch (K2), the twelfth coupling device (L) and the at least one shift element (M).

40. The double clutch transmission according to claim 24, wherein
a first forward gear (G1) is shiftable as a winding path gear via activation of the first clutch (K1), a seventh coupling device (G) and the at least one shift element (M);
a second forward gear (G2) is shiftable via activation of the second clutch (K2) and the seventh coupling device (G);
a third forward gear (G3) is shiftable via activation of the first clutch (K1) and a fourth coupling device (D);
a fourth forward gear (G4) is shiftable via activation of the second clutch (K2) and a third coupling device (C);
a fifth forward gear (G5) is shiftable via activation of the first clutch (K1) and a fifth coupling device (E);
a sixth forward gear (G6) is shiftable via activation of the second clutch (K2) and a ninth coupling device (I);
a seventh forward gear (G7) is shiftable via activation of the first clutch (K1) and a twelfth coupling device (L);
an eighth forward gear (G8) is shiftable via activation of the second clutch (K2) and an eighth coupling device (H);
a ninth forward gear (G9) is shiftable via activation of the first clutch (K1) and an eleventh coupling device (K);
a first reverse gear (R1) is shiftable via activation of the first clutch (K1) and a tenth coupling device (J);
a second reverse gear (R2) is shiftable as a winding path gear via activation of the first clutch (K1), the seventh coupling device (G) and a second shift element (N);
a third reverse gear (R3) is shiftable as a winding path gear via activation of the first clutch (K1), the eighth coupling device (H) and the second shift element (N);
a fourth reverse gear (R4) is shiftable as a winding path gear activation of via the first clutch (K1), the third coupling device (C) and the second shift element (N);
a first overdrive gear (O1) is shiftable as a winding path gear via activation of the second clutch (K2), the eleventh coupling device (K) and the at least one shift element (M); and
a second overdrive gear (O2) is shiftable as a winding path gear via activation of the second clutch (K2), the twelfth coupling device (L) and the at least one shift element (M).

41. The double clutch transmission according to claim 24, wherein
a first forward gear (G1) is shiftable as a winding path gear via activation of the first clutch (K1), a ninth coupling device (I) and the at least one shift element (M);
a second forward gear (G2) is shiftable via activation of the second clutch (K2) and the ninth coupling device (I);
a third forward gear (G3) is shiftable via activation of the first clutch (K1) and an eleventh coupling device (K);
a fourth forward gear (G4) is shiftable via activation of the second clutch (K2) and a seventh coupling device (G);
a fifth forward gear (G5) is shiftable via activation of the first clutch (K1) and a fourth coupling device (D);
a sixth forward gear (G6) is shiftable via activation of the second clutch (K2) and a third coupling device (C);
a seventh forward gear (G7) is shiftable via activation of the first clutch (K1) and a sixth coupling device (F);
an eighth forward gear (G8) is shiftable via activation of the second clutch (K2) and an eighth coupling device (H);
a ninth forward gear (G9) is shiftable via activation of the first clutch (K1) and a fifth coupling device (E);
a first reverse gear (R1) is shiftable via activation of the first clutch (K1) and a tenth coupling device (J);
a second reverse gear (R2) is shiftable as a winding path gear via activation of the second clutch (K2), the tenth coupling device (J) and the at least one shift element (M);
a third reverse gear (R3) is shiftable as a winding path gear via activation of the first clutch (K1), the seventh coupling device (G) and a second shift element (N);
a first overdrive gear (O1) is shiftable as a winding path gear via activation of the second clutch (K2), the fifth coupling device (E) and the at least one shift element (M); and
a second overdrive gear (O2) is shiftable as a winding path gear via activation of the second clutch (K2), the sixth coupling device (F) and the at least one shift element (M).

42. The double clutch transmission according to claim 24, wherein
a first forward gear (G1) is shiftable via activation of the first clutch (K1) and a twelfth coupling device (L);
a second forward gear (G2) is shiftable via activation of the second clutch (K2) and an eighth coupling device (H);
a third forward gear (G3) is shiftable via activation of the first clutch (K1) and an eleventh coupling device (K);
a fourth forward gear (G4) is shiftable via activation of the second clutch (K2) and a ninth coupling device (I);
a fifth forward gear (G5) is shiftable via activation of the first clutch (K1) and a fifth coupling device (E);
a sixth forward gear (G6) is shiftable via activation of the second clutch (K2) and a third coupling device (C);
a seventh forward gear (G7) is shiftable via activation of the first clutch (K1) and a fourth coupling device (D);
an eighth forward gear (G8) is shiftable via activation of the second clutch (K2) and a seventh coupling device (G);
a ninth forward gear (G9) is shiftable as a winding path gear via activation of the first clutch (K1), the seventh coupling device (G) and the at least one shift element (M);
a first reverse gear (R1) is shiftable via activation of the first clutch (K1) and a tenth coupling device (J);
a second reverse gear (R2) is shiftable as a winding path gear via activation of the second clutch (K2), the tenth coupling device (J) and the at least one shift element (M);
a third reverse gear (R3) is shiftable as a winding path gear via activation of the first clutch (K1), the eighth coupling device (H) and a second shift element (N); and
a crawler gear (C1) is shiftable as a winding path gear via activation of the second clutch (K2), the twelfth coupling device (L) and the at least one shift element (M).

43. The double clutch transmission according to claim 24, wherein
a first forward gear (G1) is shiftable via activation of the first clutch (K1) and an eleventh coupling device (K);
a second forward gear (G2) is shiftable via activation of the second clutch (K2) and a ninth coupling device (I);
a third forward gear (G3) is shiftable via activation of the first clutch (K1) and a tenth coupling device (J);
a fourth forward gear (G4) is shiftable via activation of the second clutch (K2) and an eighth coupling device (H);
a fifth forward gear (G5) is shiftable via activation of the first clutch (K1) and a fifth coupling device (E);
a sixth forward gear (G6) is shiftable via activation of the second clutch (K2) and a third coupling device (C);
a seventh forward gear (G7) is shiftable via activation of the first clutch (K1) and a fourth coupling device (D);
an eighth forward gear (G8) is shiftable via activation of the second clutch (K2) and a seventh coupling device (G);
a ninth forward gear (G9) is shiftable as a winding path gear via activation of the first clutch (K1), the seventh coupling device (G) and the at least one shift element (M);
a reverse gear (R1) is shiftable via activation of the first clutch (K1) and a sixth coupling device (F);
a first crawler gear (C1) is shiftable as a winding path gear via activation of the second clutch (K2), the eleventh coupling device (K) and the at least one shift element (M);
a second crawler gear (C2) is shiftable as a winding path gear via activation of the second clutch (K2), the eleventh coupling device (K) and a second shift element (N); and
an overdrive gear (O1) is shiftable as a winding path gear via activation of the first clutch (K1), the seventh coupling device (G) and the second shift element (N).

44. The double clutch transmission according to claim 24, wherein
a first forward gear (G1) is shiftable via activation of the first clutch (K1) and a fifth coupling device (E);
a second forward gear (G2) is shiftable via activation of the second clutch (K2) and a third coupling device (C);
a third forward gear (G3) is shiftable via activation of the first clutch (K1) and a sixth coupling device (F);
a fourth forward gear (G4) is shiftable via activation of the second clutch (K2) and an eighth coupling device (H);
a fifth forward gear (G5) is shiftable via activation of the first clutch (K1) and an eleventh coupling device (K);
a sixth forward gear (G6) is shiftable via activation of the second clutch (K2) and a ninth coupling device (I);
a seventh forward gear (G7) is shiftable via activation of the first clutch (K1) and a tenth coupling device (J);
an eighth forward gear (G8) is shiftable via activation of the second clutch (K2) and a seventh coupling device (G);
a ninth forward gear (G9) is shiftable as a winding path gear via activation of the first clutch (K1), the seventh coupling device (G) and the at least one shift element (M);
a first reverse gear (R1) is shiftable via activation of the second clutch (K2) and a second coupling device (B);
a second reverse gear (R2) is shiftable as a winding path gear via activation of the first clutch (K1), the second coupling device (B) and the at least one shift element (M);
a third reverse gear (R3) is shiftable as a winding path gear via activation of the first clutch (K1), the second coupling device (B) and a second shift element (N);
a first crawler gear (C1) is shiftable as a winding path gear via activation of the second clutch (K2), the fifth coupling device (E) and the at least one shift element (M);
a second crawler gear (C2) is shiftable as a winding path gear via activation of the second clutch (K2), the fifth coupling device (E) and the second shift element (N); and
an overdrive gear (O1) is shiftable as a winding path gear via activation of the first clutch (K1), the seventh coupling device (G) and the second shift element (N).

45. The double clutch transmission according to claim 24, wherein
a first forward gear (G1) is shiftable via activation of the first clutch (K1) and a sixth coupling device (F);
a second forward gear (G2) is shiftable via activation of the second clutch (K2) and an eighth coupling device (H);
a third forward gear (G3) is shiftable via activation of the first clutch (K1) and a fifth coupling device (E);
a fourth forward gear (G4) is shiftable via activation of the second clutch (K2) and a third coupling device (C);
a fifth forward gear (G5) is shiftable via activation of the first clutch (K1) and an eleventh coupling device (K);
a sixth forward gear (G6) is shiftable via activation of the second clutch (K2) and a ninth coupling device (I);
a seventh forward gear (G7) is shiftable via activation of the first clutch (K1) and a tenth coupling device (J);
an eighth forward gear (G8) is shiftable via activation of the second clutch (K2) and a seventh coupling device (G);
a ninth forward gear (G9) is shiftable as a winding path gear via activation of the first clutch (K1), the seventh coupling device (G) and the at least one shift element (M);
a first reverse gear (R1) is shiftable via activation of the second clutch (K2) and a second coupling device (B);
a second reverse gear (R2) is shiftable as a winding path gear via activation of the first clutch (K1), the second coupling device (B) and the at least one shift element (M);
a third reverse gear (R3) is shiftable as a winding path gear via activation of the first clutch (K1), the second coupling device (B) and a second shift element (N);
a first crawler gear (C1) is shiftable as a winding path gear via activation of the second clutch (K2), the sixth coupling device (F) and the at least one shift element (M); and
a second crawler gear (C2) is shiftable as a winding path gear via activation of the second clutch (K2), the sixth coupling device (F) and the second shift element (N).

46. The double clutch transmission according to claim 24, wherein
a first forward gear (G1) is shiftable as a winding path gear via activation of the first clutch (K1), a seventh coupling device (G) and the at least one shift element (M);
a second forward gear (G2) is shiftable via activation of the second clutch (K2) and a seventh coupling device (G);
a third forward gear (G3) is shiftable via activation of the first clutch (K1) and a sixth coupling device (F);
a fourth forward gear (G4) is shiftable via activation of the second clutch (K2) and an eighth coupling device (H);
a fifth forward gear (G5) is shiftable via activation of the first clutch (K1) and a tenth coupling device (J);
a sixth forward gear (G6) is shiftable via activation of the second clutch (K2) and a third coupling device (C);
a seventh forward gear (G7) is shiftable via activation of the first clutch (K1) and a fifth coupling device (E);
an eighth forward gear (G8) is shiftable via activation of the second clutch (K2) and a ninth coupling device (I);
a ninth forward gear (G9) is shiftable via activation of the first clutch (K1) and an eleventh coupling device (K);
a first reverse gear (R1) is shiftable via activation of the second clutch (K2) and a first coupling device (A);
a second reverse gear (R2) is shiftable as a winding path gear via activation of the first clutch (K1), the first coupling device (A) and the at least one shift element (M);
a third reverse gear (R3) is shiftable as a winding path gear via activation of the first clutch (K1), the first coupling device (A) and a second shift element (N);
a crawler gear (C1) is shiftable as a winding path gear via activation of the first clutch (K1), the seventh coupling device (G) and the second shift element (N);
a first overdrive gear (O1) is shiftable as a winding path gear via activation of the second clutch (K2), the fifth coupling device (E) and the at least one shift element (M);
a second overdrive gear (O2) is shiftable as a winding path gear via activation of the second clutch (K2), the eleventh coupling device (K) and the at least one shift element (M);
a third overdrive gear (O3) is shiftable as a winding path gear via activation of the second clutch (K2), the eleventh coupling device (K) and the second shift element (N); and
a fourth overdrive gear (O4) is shiftable as a winding path gear via activation of the second clutch (K2), the fifth coupling device (E) and the second shift element (N).
